(19) United States
(12) Patent Application Publication
(10) Pub. No.: US 2026/0172120 A1
(43) Pub. Date: Jun. 18, 2026

(54) PHOTONIC POLARIZATION CONTROLLER AND PHASE ROTATOR FOR OPTICAL TRANSCEIVER

(71) Applicant: NeoPhotonics Corporation, San Jose, CA (US)

(72) Inventors: Winston I. WAY, Irvine, CA (US); Jian WANG, San Jose, CA (US); Mark J. DAYEL, San Jose, CA (US); Jerry LIU, San Jose, CA (US); Kangmei LI, San Jose, CA (US); Mustafa AL-QADI, San Jose, CA (US); Kenneth A. MCGREER, San Jose, CA (US); Tony FU, Fremont, CA (US); Younes BOURA, Dublin, CA (US)

(21) Appl. No.: 19/096,139

(22) Filed: Mar. 31, 2025

Related U.S. Application Data
(60) Provisional application No. 63/735,091, filed on Dec. 17, 2024.

(51) Int. Cl. H04B 10/63; H04B 10/40; H04B 10/54; H04B 10/61; H04J 14/06

(52) U.S. Cl. CPC H04B 10/63; H04B 10/40; H04B 10/54; H04B 10/6151; H04J 14/06

(57) ABSTRACT

A self-homodyne detection coherent transceiver includes a first analog adaptive polarization controller (APC) configured to split the remotely sent local oscillator signal into two portions, including a first remotely sent local oscillator signal and a second remotely sent local oscillator signal; a second analog APC configured to split a polarization multiplexed signal into a first data signal and a second data signal; an analog adaptive phase rotator (APR) coupled to an output of the first analog APC, the analog APR configured to control respective phases of the first remotely sent local oscillator signal and the second remotely sent local oscillator signal for carrier phase error compensation; and a 4-level pulse amplitude modulation (PAM4) digital signal processor (DSP) chip coupled to outputs of a coherent receiver, which includes the first analog APC, the second analog APC, and the analog APR followed by a coherent receiver circuit.

### CROSS-REFERENCE TO RELATED APPLICATION

This Patent Application claims priority to U.S. Patent Application No. 63/735,091, filed on Dec. 17, 2024, and entitled “PHOTONIC POLARIZATION CONTROLLER AND PHASE ROTATOR FOR SELF-HOMODYNE COHERENT TRANSCEIVER.” The disclosure of the prior Application is considered part of and is incorporated by reference into this Patent Application.

### TECHNICAL FIELD

The present disclosure relates generally to optical transceivers with at least one photonic polarization controller and a phase rotator.

### BACKGROUND

Intensity modulation direct detection (IMDD) may be used by an optical transceiver (TRX) for transmitting optical signals in fiber-optic communication systems. Intensity modulation (IM) and direct detection (DD) are two key concepts of IMDD. A transmitter (TX) may use IM to modulate an optical carrier's intensity (e.g., power level) directly by a data signal. IM typically involves varying an output power of a laser diode or another type of light source based on an input electrical signal (e.g., binary or multi-level). A receiver (RX) may use DD to directly measure an intensity of an incoming optical signal, for example, by using a photodetector (e.g., a photodiode). A signal intensity detected by the photodetector may be proportional to the incoming optical signal, without requiring a local oscillator or coherent mixing. In contrast, for self-homodyne detection (SHD) transceivers, the transmitter sends both a local-oscillator (LO) optical signal as reference and a modulated optical signal as data. The SHD receiver optically mixes the received LO with the received data signal to form a coherent interference wherein either or both the amplitude and phase of the optical data signal can be detected and reconstructed, providing for “coherent” data transmission.

Pulse amplitude modulation with 4 levels (PAM4) is a multilevel modulation format used in optical and electrical communication systems, including modern high-speed optical transceivers. Instead of using binary (two-level) encoding, PAM4 encodes data using four distinct amplitude levels, enabling the transmission of more bits per symbol.

Optical transceivers may be used in different “range” classes indicating the nominal length of SMF (single-mode fiber) or MMF (multi-mode fiber) they are optimized for. Common range classes include “SR” (short-range <˜300 m MMF), “DR” (direct reach <=˜500 m SMF), “FR” (far reach ˜2 km SMF), “LR” (long reach ˜10 km SMF), “ER” (extended reach ˜40 km SMF), “ZR” (extra-extended reach ˜80 km SMF), and related variations. Direct reach (DR) optical transceivers for instance may differ in a number of optical lanes and respective optical interfaces. For example, DR4 may refer to a DR optical transceiver that has four optical lanes, whereas DR8 may refer to a DR optical transceiver that has eight optical lanes. DR optical transceivers may be used in the context of high-speed Ethernet standards, specifically for 400 gigabyte (Gb) Ethernet and 800 Gb Ethernet, respectively. DR4 can be split into four 100 Gb optical lanes for interoperability with individual 100 Gb devices, whereas DR8 can be split into eight 100 Gb optical lanes or two 400 Gb optical lanes for flexibility in network configurations.

### SUMMARY

In some implementations, a self-homodyne detection (SHD) coherent transceiver includes a receiver configured to receive a polarization-multiplexed signal, comprising two data signals having orthogonal polarizations and carrying different sets of information, and a remotely sent local oscillator signal, wherein the receiver comprises: a first analog adaptive polarization controller (APC) configured to receive the remotely sent local oscillator signal, the first analog APC comprising a first polarization splitter rotator and a plurality of first phase shifters for polarization control of the remotely sent local oscillator signal, wherein the first analog APC is configured to split the remotely sent local oscillator signal into two portions, including a first remotely sent local oscillator signal and a second remotely sent local oscillator signal; a second analog APC configured to receive the polarization-multiplexed signal, the second analog APC comprising a second polarization splitter rotator and a plurality of second phase shifters for signal polarization control, wherein the second analog APC is configured to split the polarization-multiplexed signal into a first data signal and a second data signal in orthogonal polarization states; an analog adaptive phase rotator (APR) coupled to an output of the first analog APC, the analog APR comprising a plurality of third phase shifters configured to control respective phases of the first remotely sent local oscillator signal and the second remotely sent local oscillator signal for carrier phase error compensation; and a 4-level pulse amplitude modulation (PAM4) digital signal processor (DSP) chip coupled to outputs of a coherent receiver, which includes the first analog APC, the second analog APC, and the analog APR followed by a coherent receiver circuit.

In some implementations, a self-homodyne detection (SHD) coherent transceiver includes a coherent receiver configured to receive a polarization-multiplexed signal that includes a single-polarization data signal and a remotely sent local oscillator signal, the single-polarization data signal and the remotely sent local oscillator signal having orthogonal polarizations, wherein the coherent receiver comprises: an analog adaptive polarization controller (APC) configured to receive the polarization-multiplexed signal, including the single-polarization data signal and the remotely sent local oscillator signal, the analog APC comprising a plurality of phase shifters for separating the single-polarization data signal and the remotely sent local oscillator signal; an optical hybrid having a first input coupled to a first output port of the analog APC, for receiving the single-polarization data signal, and coupled to a second output port of the analog APC, for receiving the remotely sent local oscillator signal; and a 4-level pulse amplitude modulation (PAM4) digital signal processor (DSP) chip coupled to output ports of the optical hybrid.

In some implementations, a polarization-multiplexed intensity modulation direct detection (IMDD) transceiver includes a receiver configured to receive a polarization-multiplexed pulse amplitude modulation (PAM) signal, comprising two PAM data signals having orthogonal polarizations and carrying different sets of information, wherein the receiver comprises: an analog adaptive polarization controller (APC) comprising a plurality of PIN-junction phase shifters for signal polarization control, wherein the analog APC is configured to split the polarization-multiplexed PAM signal into a first PAM data signal and a second PAM data signal; one or more semiconductor optical amplifiers (SOAs) coupled to the analog APC to compensate for loss introduced by the plurality of PIN-junction phase shifters; and a PAM digital signal processor (DSP) chip comprising: a first analog-to-digital converter (ADC) configured to convert the first PAM data signal into a first digital signal; and a second ADC configured to convert the second PAM data signal into a second digital signal, wherein the PAM DSP chip is configured to process the first digital signal and the second digital signal.

In some implementations, a self-homodyne detection (SHD) coherent transceiver includes a coherent receiver portion that receives a two-wavelength polarization-multiplexed signals from the same fiber from another SHD coherent transceiver, the coherent receiver portion comprising: an optical interleaver configured to split each of the two-wavelength polarization-multiplexed signals to two paths, including a first path and a second path, wherein the optical interleaver is configured to provide a first single-polarization data signal and a first single-polarization remotely sent local oscillator signal to the first path, and provide a second single-polarization data signal and a second single-polarization remotely sent local oscillator signal to the second path; and two sets of coherent receivers, including a first coherent receiver and a second coherent receiver, wherein the first coherent receiver, associated with the first path, comprises: a first analog adaptive polarization controller (APC) coupled to a first output of the optical interleaver; and a first optical hybrid configured to receive the first single-polarization data signal and the first single-polarization remotely sent local oscillator, and generate a first set of in-phase and quadrature (IQ) component signals; a first photo-diode pair configured to convert the first set of IQ component signals into first electrical signals; and a first transimpedance amplifier pair coupled between the first photo-diode pair and a first pair of analog-to-digital converter circuits integrated within a 4-level pulse amplitude modulation (PAM4) DSP chip, and wherein the second coherent receiver, associated with the second path, comprises: a second analog APC coupled to a second output of the optical interleaver; a second optical hybrid configured to receive the second single-polarization data signal and the second single-polarization remotely sent local oscillator, and generate a second set of IQ component signals; a second photo-diode pair configured to convert the second set of IQ component signals into second electrical signals; and a second transimpedance amplifier pair coupled between the second photo-diode pair and a second pair of analog-to-digital converter circuits integrated within the PAM4 DSP chip.

### BRIEF DESCRIPTION OF THE DRAWINGS

FIG. 1A shows an IMDD system according to one or more implementations.

FIG. 1B shows an SHD coherent system according to one or more implementations.

FIG. 1C shows an SHD coherent system according to one or more implementations.

FIG. 2A shows an SHD coherent transceiver according to one or more implementations.

FIG. 2B shows an SHD coherent transceiver according to one or more implementations.

FIG. 3 shows an SHD coherent transceiver according to one or more implementations.

FIG. 4A shows a low-cost pilot tone recovery circuit according to one or more implementations.

FIG. 4B shows an operational amplifier-based oscillator according to one or more implementations.

FIG. 5A shows a heater driving circuit and a heater response function according to one or more implementations.

FIG. 5B shows a heater driving circuit and a heater response function according to one or more implementations.

FIG. 6 shows an SHD coherent system according to one or more implementations.

FIG. 7 shows an SHD coherent system according to one or more implementations.

FIG. 8A shows a photonic integrated circuit (PIC) of an SHD coherent transceiver according to one or more implementations.

FIG. 8B shows a PIC of an SHD coherent transceiver according to one or more implementations.

FIG. 9 shows a PIC of an optical transceiver according to one or more implementations.

FIG. 10 shows a polarization-multiplexed IMDD transceiver according to one or more implementations.

### DETAILED DESCRIPTION

The following detailed description of example implementations refers to the accompanying drawings. The same reference numbers in different drawings may identify the same or similar elements.

Today, optical transceivers based on PAM4 IMDD are the main vehicle for intra-data-center optical interconnects. These optical transceivers operate at speeds ranging from 100 gigabytes per second (Gb/s) to 800 Gb/s, and soon will grow to 1.6 terabytes per second (Tb/s) and 3.2 Tb/s. Most of these transceivers are DR4 or DR8 within a distance of 500 meters. DR4 and DR8 transceiver modules transmit and receive data by using 8 (4 transmit and 4 receive) and 16 (8 transmit and 8 receive) parallel optical fibers, respectively, and require the use of multi-fiber push-on (MPO) connectors. An MPO connector is constrained in size, and can only support either an array of 12 fibers or two arrays of 24 fibers. Consequently, the number of parallel fibers is constrained by the size of the transceiver. A solution to increasing the available bandwidth for a fixed number of fibers is to use polarization multiplexing at a transmitter and polarization demultiplexing at a receiver.

A coherent receiver may use a coherent DSP to perform chromatic dispersion and component bandwidth compensation, polarization demultiplexing, polarization mode dispersion (PMD), and polarization-dependent-loss (PDL) compensation, and carrier frequency and phase recovery. A coherent DSP is a complex, power-intensive device. For example, DSPs increase a system cost of an optical transceiver based on complexity. Additionally, DPSs, such as coherent DSPs, can be power-intensive devices. For example, a DSP may include analog-to-digital converters (ADCs) and one or more processing cores that perform DSP algorithms and functions in a digital domain. A DSP consumes more power when tasked to perform more complex DSP algorithms and/or a greater quantity of functions. Thus, simplifying a DSP either by reducing complexity of DSP algorithms and/or reducing a quantity of functions can save both system costs and system resources, such as requiring fewer memory resources and/or fewer power resources.

An SHD coherent optical transceiver is a type of optical transceiver used for intra-data-center applications that may use polarization multiplexing of a modulated signal and a copy of the transmitter continuous wave (CW) laser (e.g., a remotely sent local oscillator (LO) signal) at a transmitter and polarization demultiplexing at a simplified coherent receiver in which wavelength locking between transmitter and LO wavelengths is no longer needed, and the portion of DSP algorithms related to carrier frequency offset (CFO) can be omitted. SHD coherent optical transceivers can support multiple wavelengths (e.g., coarse wavelength division multiplexing (CWDM), local area network wavelength division multiplexing (LWDM), or dense wavelength division multiplexing (DWDM)) for future intra-data center capacity growth.

The SHD coherent optical transceiver may use an adaptive polarization controller (APC) to align and separate the two orthogonal polarizations into two separate polarization signals (e.g., X-Y signal polarization demultiplexing). In contrast to a conventional coherent transceiver, an SHD coherent transceiver reduces power consumption and cost.

Some implementations are directed to an optical transceiver that performs X-Y signal polarization demultiplexing in an analog domain (e.g., by an analog APC, such as APC2) or by a simplified DSP in the digital domain. Additionally, polarization of a remotely sent (transmitted) single-polarization LO can be controlled by an analog APC, such as APC1, and a polarization orientation of the remotely transmitted single-polarization LO signal can be controlled by an analog adaptive phase rotator (APR). The analog APR is used to replace carrier phase recovery in a DSP. The optical transceiver may include a simplified DSP, such as a PAM4 DSP, with many digital functions that would otherwise be performed by a coherent DSP being shifted to the analog domain.

A PAM4 DSP of a PAM4 receiver has a structure in which four independent lanes of finite-impulse-response (FIR) linear equalizers and nonlinear decision-feedback equalizers (DFEs) are used. The PAM4 modulation format is backward compatible with older generations of PAM4 transceivers but a PAM4 DSP has an intentionally limited chromatic dispersion (CD) compensation capability.

One or more implementations described herein may be directed to a thermally or electrically controlled automatic silicon photonic polarization controller and phase rotator for a self-homodyne coherent-receiver and a polarization demultiplexed direct-detection receiver.

One or more implementations described herein may be directed to a bidirectional self-homodyne coherent transceiver based on silicon photonics circuitry integrated with an adaptive polarization controller and DSP using a simplified MIMO configuration.

One or more implementations described herein are directed to a thermally or electrically controlled APC used in polarization-multiplexed PAM4 IMDD transceivers.

One or more implementations described herein may be directed to an SHD coherent transceiver that uses a conventional PAM4 DSP chip in an optical link which has close to zero chromatic dispersion (e.g., a DR4 or DR8 transceiver operating at 1310 nm), or an optical link which has sufficient CD compensation in the optical link. Under these conditions, the SHD coherent transceiver can use a PAM4 DSP (e.g., a PAM4 receiver DSP) instead of a conventional coherent DSP.

One or more implementations described herein may be directed to an SHD coherent transceiver based on a PAM4 DSP chip and an optical device structure that is backward compatible with older generation DRn PAM transceivers. With an optical link which has close to zero chromatic dispersion (e.g., a DR4 or DR8 transceiver operating at 1310 nm), or an optical link which has sufficient CD compensation in the optical link, the PAM4 DSP can be designed to be backward compatible with older generation PAM4 DSP signals, since new generation PAM4 DSP signals and older generation PAM4 DSP signals have the same modulation format. Furthermore, the same optical device which is used for coherent modulation and detection should allow IMDD by switching to a modified IMDD PAM4 transceiver operation condition.

One or more implementations described herein may be directed to an SHD coherent transceiver with thermally or electrically controlled endless silicon photonic polarization controllers. A silicon photonic 4-stage Mach-Zehnder interferometer (MZI) may be used for signal polarization rotation (APC2), which may demultiplex the two polarizations of the signal. A silicon photonic 2-stage Mach-Zehnder interferometer may be used for a remote LO (APC1), which can equally split the power of the remote LO and feed to two 90° optical hybrids.

One or more implementations described herein may be directed to an SHD coherent transceiver with an endless silicon photonic APR to compensate for a carrier phase error due to laser linewidth and length mismatch between a modulated signal and a remote LO. An endless APR is an APR that can continuously advance the rotation phase angle in either direction without need to rewind or reset. Carrier phase error is expected as long as a laser has a finite linewidth, and/or when there is a length mismatch between a modulated signal and a remote LO. An endless silicon photonic APR based on three stages of Mach-Zehnder interferometer (MZI) and with pilot tone modulation is implemented to receive a remote LO, in order to correct the I-Q phase error (e.g., to de-rotate the I-Q constellation to reduce or prevent I-Q crosstalk).

One or more implementations described herein may be directed to an optical network architecture for SHD coherent transceivers using dual-polarization signals. The optical network architecture may use bi-directional CWDM/LWDM/DWDM transmission with odd and even wavelengths propagating in opposite directions. Higher and higher link capacity is needed, considering continuous intra-data center traffic growth in the future, especially due to the drastically increasing AI/ML traffic. To increase the link capacity, more optical fibers or wavelengths can be added. To add more fibers, multi-core optical fibers are preferred, to minimize the impact of length mismatch between a signal and a remote LO. A main advantage of using SHD coherent detection over IMDD PAM4 is that SHD coherent detection can be upgraded to CWDM/LWDM/DWDM near 1310 nm to support continuous link capacity growth without adding any more optical fibers. For example, a bi-directional WDM optical network architecture may be provided.

One or more implementations described herein may be directed to PIN junction-based phase shifters used for fast pilot tone demodulation in both APC and APR applications, in replacement of thermal-based phase shifters. A silicon photonics PIN junction-based optical waveguide can alter the optical phase based on free carrier effect, under a forward bias voltage. A PIN junction-based phase shifter can respond as fast as 50 MHz, which is four orders of magnitude faster than a typical heater-based thermal phase shifter.

As mentioned above, one or more implementations may be directed to a fast APC which can be used for either SHD coherent optical transceivers or polarization-multiplexed PAM4 IMDD optical transceivers.

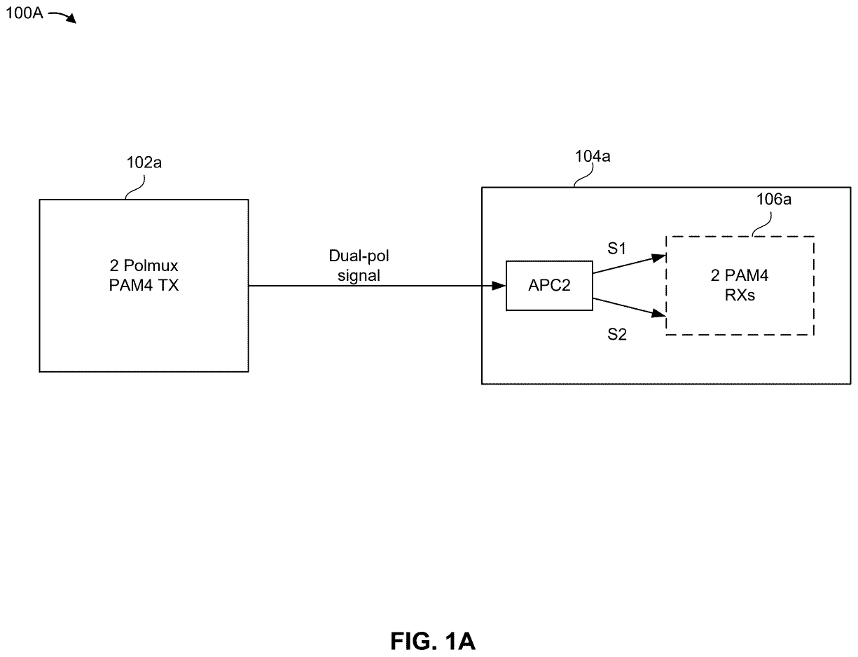

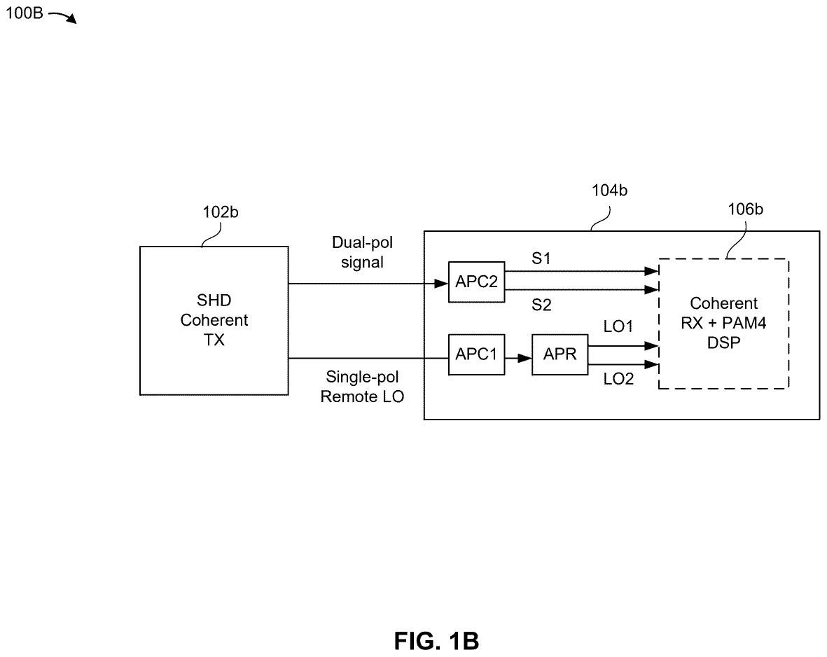

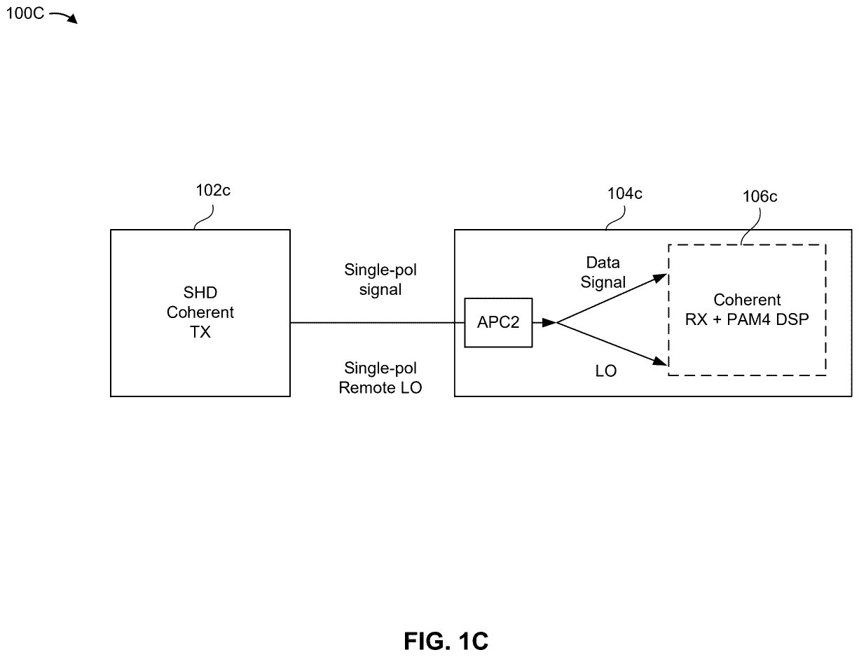

FIG. 1A shows an IMDD system 100A according to one or more implementations. The IMDD system 100A includes a transmitter 102a and a receiver 104a. The transmitter 102a and the receiver 104a may be parts of respective optical transceivers. For example, the transmitter 102a and the receiver 104a may include respective transceiver photonic integrated circuits (PICs), such as silicon-photonic integrated circuits. The transmitter 102a may include two IMDD polarization multiplexed PAM4 transmitters (TXs) that are configured to transmit a polarization multiplexed signal along a transmission optical fiber to the receiver 104a. The polarization multiplexed signal may be a dual-polarization signal that includes two data signals having orthogonal polarizations and carrying different sets of information. The receiver 104a may include a second analog APC (APC2) that includes a second polarization splitter and a plurality of second phase shifters for signal polarization control. The second analog APC (APC2) may use the second polarization splitter and the plurality of second phase shifters to split the polarization multiplexed signal into a first data signal S1 and a second data signal S2. The second phase shifters implemented in the IMDD system 100A are p-n junction-based phase shifters (e.g., PIN junction-based phase shifters). The second analog APC (APC2) also includes semiconductor optical amplifiers (SOAs), included on a silicon photonics platform through hybrid integration, which are used to compensate for loss introduced by the p-n junction-based phase shifters.

The receiver 104a may include two PAM4 receivers 106a that receive the first data signal S1 and the second data signal S2, respectively. The two PAM4 receivers 106a may each include a PAM4 DSP (e.g., a PAM4 DSP chip) for digital processing.

As indicated above, FIG. 1A is provided as an example. Other examples may differ from what is described with regard to FIG. 1A.

FIG. 1B shows an SHD coherent system 100B according to one or more implementations. The SHD coherent system 100B includes an SHD optical transmitter 102b and an SHD optical receiver 104b. The SHD optical transmitter 102b and the SHD optical receiver 104b may be parts of respective optical coherent transceivers. For example, the SHD optical transmitter 102b and the SHD optical receiver 104b may include respective transceiver PICs.

The SHD optical transmitter 102b may transmit and the SHD optical receiver 104b may receive a polarization multiplexed signal, transmitted on a transmission optical fiber. The polarization multiplexed signal may be a dual-polarization signal comprising two data signals having orthogonal polarizations and carrying different sets of information. In addition, the SHD optical transmitter 102b may transmit and the SHD optical receiver 104b may receive a remotely sent local oscillator signal, transmitted on another transmission optical fiber in parallel to the polarization multiplexed signal. The remotely sent local oscillator signal may be a single-polarization signal.

The SHD optical receiver 104b may include a first analog adaptive polarization controller APC1 configured to receive the remotely sent local oscillator signal. The first analog APC (APC1) may include a first polarization splitter and a plurality of first phase shifters for polarization control of the remotely sent local oscillator signal. The first analog APC (APC1) may use the first polarization splitter and the plurality of first phase shifters to split the remotely sent local oscillator signal into two portions, including a first remotely sent local oscillator signal LO1 and a second remotely sent local oscillator signal LO2.

The SHD optical receiver 104b may further include a second analog APC (APC2) configured to receive the polarization multiplexed signal. The second analog APC (APC2) may include a second polarization splitter and a plurality of second phase shifters for signal polarization control. The second analog APC (APC2) may use the polarization splitter and the plurality of second phase shifters to split the polarization multiplexed signal into a first data signal S1 and a second data signal S2.

The SHD optical receiver 104b may further include an analog adaptive phase rotator (APR) coupled to an output of the first analog APC (APC1). The analog APR may include a plurality of third phase shifters configured to control respective phases of the first remotely sent local oscillator signal and the second remotely sent local oscillator signal for carrier phase error compensation. In some implementations, the analog APR may be an endless phase rotator to compensate for a phase delay difference between the polarization multiplexed signal and the remotely sent local oscillator signal.

The SHD optical receiver 104b may further include receiver circuitry 106b that includes a coherent receiver circuit and a 4-level pulse amplitude modulation (PAM4) digital signal processor (DSP) chip. The PAM4 DSP chip may be coupled to outputs of an SHD coherent receiver, which includes the first analog APC (APC1), the second analog APC (APC2), the analog APR, and the coherent receiver circuit. The coherent receiver circuit is arranged downstream from, or follows, the first analog APC (APC1), the second analog APC (APC2), the analog APR. The coherent receiver circuit may include optical hybrids, photo-diode pairs (e.g., as opto-electrical (O/E) converters), and transimpedance amplifiers (TIAs) arranged upstream from, or prior to, the PAM4 DSP chip. In other words, the coherent receiver circuit may be coupled to the outputs of the second analog APC (APC2) and the analog APR, and the PAM4 DSP chip may be coupled to the output of the coherent receiver circuit.

The second analog APC (APC2) may perform X-Y signal polarization demultiplexing in the analog domain. In addition, a polarization of the remotely sent local oscillator signal and thus, the division of power between LO1 and LO2 can be controlled by the first analog APC (APC1). In addition, a phase of the remotely sent local oscillator signal can be controlled by the analog APR. As a result, a coherent DSP can be replaced by a PAM4 DSP, arranged after the coherent receiver circuit.

As indicated above, FIG. 1B is provided as an example. Other examples may differ from what is described with regard to FIG. 1B.

FIG. 1C shows an SHD coherent system 100C according to one or more implementations. The SHD coherent system 100C includes an SHD optical transmitter 102c and an SHD optical receiver 104c. The SHD optical transmitter 102c and the SHD optical receiver 104c may be parts of respective optical coherent transceivers. For example, the SHD optical transmitter 102c and the SHD optical receiver 104c may include respective transceiver PICs.

The SHD optical transmitter 102c may be a coherent transmitter configured to generate and transmit a polarization-multiplexed signal that includes a single-polarization data signal and a remotely sent local oscillator signal. The single-polarization data signal and the remotely sent local oscillator signal may have orthogonal polarizations. The multiplexed signal may be transmitted on a single transmission optical fiber. The SHD optical receiver 104c may be a coherent receiver configured to receive the multiplexed signal that includes the single-polarization data signal and the remotely sent local oscillator signal. The SHD optical receiver 104c may include the second analog APC (APC2) that receives the multiplexed signal. The second analog APC (APC2) may include a polarization splitter and a plurality of phase shifters (e.g., the plurality of second phase shifters) for separating the single-polarization data signal and the remotely sent local oscillator signal.

The SHD optical receiver 104c may further include receiver circuitry 106c that includes a coherent receiver circuit and a PAM4 DSP chip. The coherent receiver circuit may include an optical hybrid having a first input coupled to a first output port of the second analog APC (APC2), for receiving the single-polarization data signal, and coupled to a second output port of the second analog APC (APC2), for receiving the remotely sent local oscillator signal. The PAM4 DSP chip may be coupled to the TIA output ports of the coherent receiver.

A system that uses only a single transmission optical fiber may be more compatible with data center infrastructure than a two-transmission optical fiber system. The transmitter uses only one in-phase-quadrature modulator (IQM) instead of two polarization-multiplexed IQMs, and uses only half of the coherent receiver hardware due to the single-instead of dual-polarization detection, therefore saving 50% of the hardware commensurate with having 50% less capacity for data transmission compared to a two-transmission optical fiber system. In addition, due to the fact that the second analog APC (APC2) and the coherent hybrid coupler (part of a coherent receiver) are integrated on the same silicon photonic chip, no APR is needed, which further simplifies the hardware. The IQM may be based on silicon photonic Mach-Zehnder modulators (MZMs).

As indicated above, FIG. 1C is provided as an example. Other examples may differ from what is described with regard to FIG. 1C.

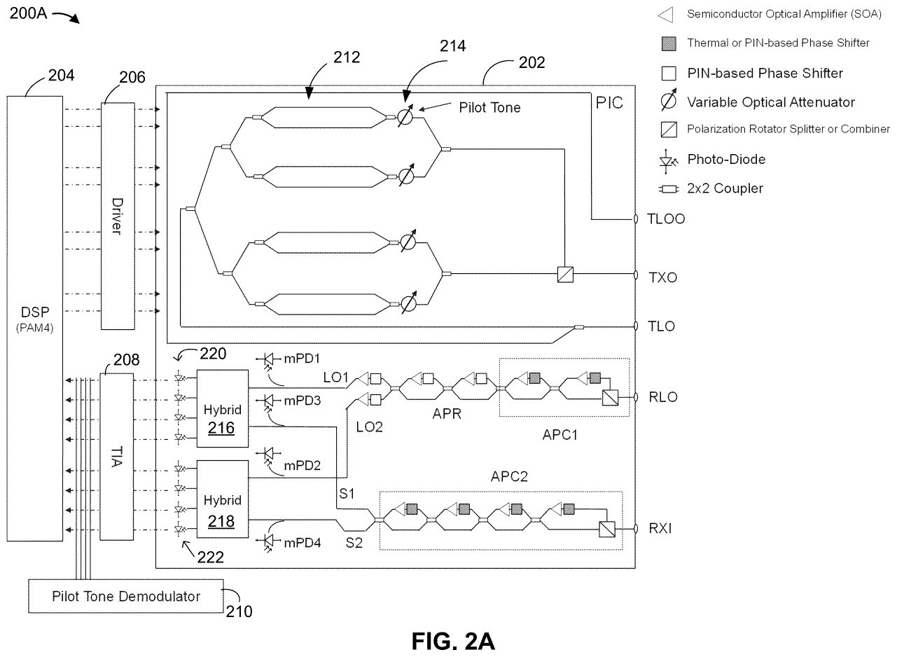

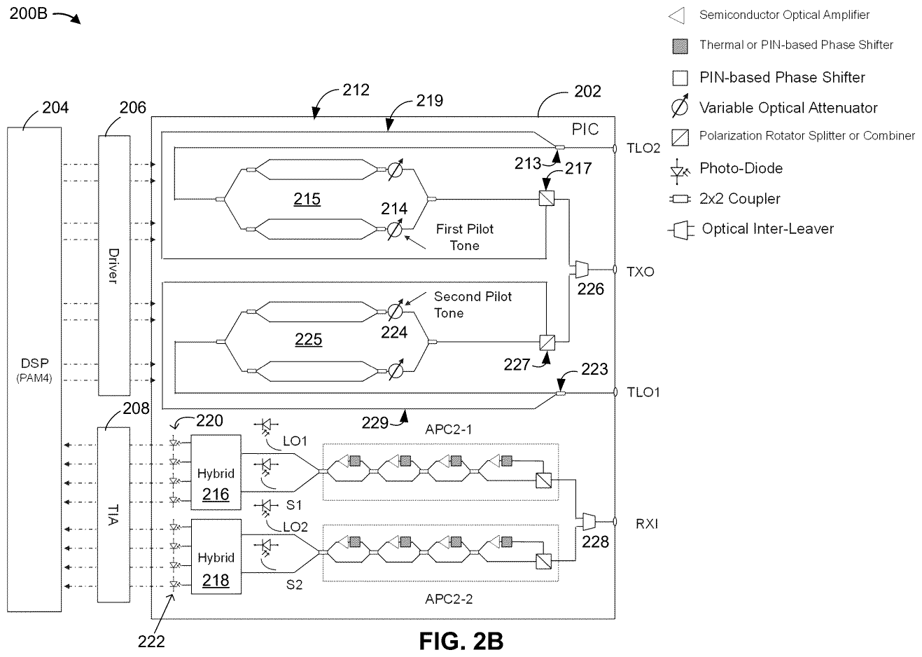

FIG. 2A shows an SHD coherent transceiver 200A according to one or more implementations. The SHD coherent transceiver 200A may correspond to an optical transceiver of the SHD coherent system 100B described in connection with FIG. 1B. The SHD coherent transceiver 200A may include a PIC 202, a PAM4 DSP chip 204, a driver 206, and TIA circuit 208, and a pilot tone demodulator 210.

The PIC 202 may include an LO input port TLO for receiving an LO signal from a laser source, an LO transmission port TLOO for transmitting a remotely sent local oscillator signal, a signal transmission port TXO for transmitting a TX polarization-multiplexed signal, an LO reception port RLO for receiving a remotely sent local oscillator signal from another optical transceiver, and a signal reception port RXI for receiving a polarization-multiplexed signal from another optical transceiver. The PIC 202 may include a coherent IQM transmitter 212 configured to generate the TX polarization-multiplexed signal. The coherent IQM transmitter 212 may use the LO signal received from the LO input port TLO for generating the TX polarization-multiplexed signal. The TX polarization-multiplexed signal may include two data signals having orthogonal polarizations and carrying different sets of information. A polarization splitter rotator/combiner functions as a polarization splitter rotator (PSR) at the receiver and functions as a polarization rotator combiner (PRC) at the transmitter.

The coherent IQM transmitter 212 may include a PIN-junction-based variable optical attenuator (VOA) 214, or another type of sub-data rate modulator, for adding one pilot tone to the TX polarization-multiplexed signal. For example, the PIN-junction-based VOA 214 may add, via amplitude modulation, a first pilot tone to the I-phase of the X-polarized TX signal. The first pilot tone may be used for phase tracking of remotely sent LO and/or polarization tracking of polarization-multiplexed signal at an optical receiver. Once the polarizations of an incoming signal start to drift, polarization crosstalk occurs. A pilot tone may enable the optical receiver to perform polarization tracking and correction to be performed in real-time, without affecting data traffic. The pilot tone may assist in polarization demultiplexing and in-phase and quadrature-phase (I/Q) de-rotation at the optical receiver. A PIN junction-based variable optical attenuator (VOA) at the transmitter side may enable megahertz-range pilot tone modulation, which may be used for a fast control loop implementation, which is not possible to achieve by a heater-based VOA.

The PIC 202 may further include the first analog APC (APC1) and the analog APR coupled in series to the LO reception port RLO, and the second analog APC (APC2) coupled to the signal reception port. The first analog APC (APC1) includes a first polarization splitter rotator (e.g., a PSR) and a plurality of first phase shifters for splitting the remotely sent local oscillator signal into two portions, including a first remotely sent local oscillator signal LO1 and a second remotely sent local oscillator signal LO2. For example, the first analog APC (APC1) may include a two-stage MZI for equally splitting the optical power of a remotely sent local oscillator signal. The analog APR may include a plurality of third phase shifters configured to control respective phases of the first remotely sent local oscillator signal LO1 and the second remotely sent local oscillator signal LO2 for carrier phase error compensation. For example, the analog APR may include a three-stage MZI, which may be used to correct I-Q phase error (e.g., to de-rotate an I-Q constellation to reduce or prevent I-Q crosstalk). The second analog APC (APC2) may include a second polarization splitter rotator (e.g., a PSR) and a plurality of second phase shifters for splitting the polarization-multiplexed signal into a first data signal S1 and a second data signal S2. For example, the second analog APC (APC2) may include a four-stage MZI for demultiplexing the two polarizations of the polarization-multiplexed signal. The PIC 202 may operate fully in an analog domain, with only analog components.

A stage of an MZI may be referred to as a mixer stage. Each mixer stage of an MZI may be coupled by a 2×2 coupler, such as a 3 dB coupler, a 2×2 multi-mode interferometer (MMI), and/or a directional coupler. The 2×2 coupler of each mixer stage may ideally have a 50/50 split ratio. With a 50/50 split ratio, light that enters an input port of a 2×2 coupler is transmitted equally to each of two output ports of the 2×2 coupler. A phase shifter may be any component that is capable of adjusting a phase delay of light that travels through the phase shifter. For example, a phase shifter may employ a metal alloy resistive heater, or a doped silicon resistive heater (e.g., a thermally-controlled phase shifter) that uses a thermo-optic effect to tune the phase of light passing through the phase shifter. Alternatively, a phase shifter may be a P(I)N junction-based phase shifter (e.g., a silicon photonics PIN junction phase shifter) that tunes the phase of light passing through the phase shifter based on a controlled forward bias voltage applied to the phase shifter. In other words, adjusting the controlled forward bias voltage adjusts the phase shift. PIN junction-based phase shifters are faster and more responsive than thermally-controlled phase shifters, but introduce losses (e.g., attenuation). Thus, one or more semiconductor optical amplifiers (SOAs), included on a silicon photonics platform through hybrid integration, may be used to compensate for loss introduced by the PIN junction-based phase shifters.

An APC can be used for polarization demultiplexing or remote LO power splitting, depending on the settings of the phase shifters, and in some cases, depending on a number of mixer stages. For example, polarization demultiplexing or remote LO power splitting can be achieved by setting a relative phase of the phase shifters correctly. The optical outputs (e.g., top output and bottom output) of the APC may then be guided to a coherent receiver circuit that includes two optical hybrids 216 and 218. For example, a first optical hybrid 216 may receive the first data signal S1 and the first remotely sent local oscillator signal LO1, and generate a first set of in-phase and quadrature (IQ) component signals. A second optical hybrid 218 may receive the second data signal S2 and the second remotely sent local oscillator signal LO2, and generate a second set of IQ component signals.

In some implementations, the plurality of third phase shifters of the analog APR are PIN junction-based phase shifters. Accordingly, the PIC 202 may include one or more SOAs coupled to the analog APR to compensate for loss introduced by the plurality of third phase shifters. In some implementations, the analog APR may include the one or more SOAs.

In some implementations, the plurality of first phase shifters and the plurality of second phase shifters are PIN junction-based phase shifters. Accordingly, the PIC 202 may include one or more first SOAs coupled to the first analog APC (APC1) to compensate for loss introduced by the plurality of first phase shifters. For example, the first analog APC (APC1) may include the one or more first SOAs. Additionally, the PIC 202 may include one or more second SOAs coupled to the second analog APC (APC2) to compensate for loss introduced by the plurality of second phase shifters. For example, the second analog APC (APC2) may include the one or more second SOAs. All the SOAs mentioned above are included on a silicon photonic platform through hybrid integration.

In some implementations, the plurality of first phase shifters and the plurality of second phase shifters are thermally-controlled phase shifters, and the plurality of third phase shifters are PIN junction-based phase shifters.

In some implementations, the plurality of first phase shifters, the plurality of second phase shifters, and the plurality of third phase shifters are PIN junction-based phase shifters (e.g., silicon photonics PIN junction phase shifters)

The PIC 202 may further include a plurality of low-speed monitoring photo-diodes, or mPDs, to monitor the outputs of the first analog APC (APC1), the second analog APC (APC2), and the analog APR. For example, the plurality of monitoring photo-diodes may include a first monitoring photo-diode mPD1 and a second monitoring photo-diode mPD2 respectively coupled to a first pair of output ports of the analog APR. The first monitoring photo-diode mPD1 may receive a portion of the first remotely sent local oscillator signal LO1 to measure an optical power thereof. The second monitoring photo-diode mPD2 may receive a portion of the second remotely sent local oscillator signal LO2 to measure an optical power thereof.

Additionally, the plurality of monitoring photo-diodes may include a third monitoring photo-diode mPD3 and a fourth monitoring photo-diode mPD4 respectively coupled to a second pair of output ports of the second analog APC (APC2). The third monitoring photo-diode mPD3 may receive a portion of the first data signal S1 to measure an amplitude of the polarization tracking pilot tone. The fourth monitoring photo-diode mPD4 may receive a portion of the second data signal S2 to measure an amplitude of the polarization tracking pilot tone.

The coherent receiver circuit, coupled to the second analog APC (APC2) and the analog APR, may include the first optical hybrid 216, the second optical hybrid 218, a first photo-diode pair 220 configured to convert the first set of IQ component signals into first electrical signals, a second photo-diode pair 222 configured to convert the second set of IQ component signals into second electrical signals, and couple to the TIA circuit 208. The TIA circuit 208 may include a first transimpedance amplifier pair coupled between the first photo-diode pair 220 and a first pair of analog-to-digital converter circuits within the PAM4 DSP chip 204. The TIA circuit 208 may also include a second transimpedance amplifier pair coupled between the second photo-diode pair 222 and a second pair of analog-to-digital converter circuits within the PAM4 DSP chip 204.

The pilot tone demodulator 210 may be used for phase tracking. The polarization-multiplexed signal may include a first pilot tone. The output of the analog APR may include a first pair of output ports that output respective polarization components of the remotely sent LO. The output of the second analog APC (APC2) may include a second pair of output ports that output respective polarization components including the first pilot tone. The pilot tone demodulator 210 may be part of a phase tracking circuit, a portion of which may be included in a microcontroller or another type of processing circuit. The pilot tone demodulator 210 may be coupled to the outputs of the TIAs of the TIA circuit 208 for demodulating the first pilot tone. For example, the pilot tone demodulator 210 may receive a first phase component and a second phase component of a first polarization (e.g., an X or Y polarization), the second phase component being in quadrature to the first phase component, and the first phase component and the second phase component including the first pilot tone. The first phase component may be an in-phase component or a quadrature-phase component, and the second phase component may be the other phase component. Thus, as used herein, “first phase component” and “second phase component” refer to phase components that are in quadrature. In some cases, the pilot tone demodulator 210 may receive an in-phase component and a quadrature-phase component of a first polarization (e.g., an X-polarization), the in-phase component and the quadrature-phase component including the first pilot tone. The pilot tone demodulator 210 may include a lock-in amplifier or a field-programmable gate array (FPGA) for demodulating the first pilot tone.

A phase tracking circuit may monitor amplitudes of the first pilot tone included in the in-phase component and the quadrature-phase component, and calibrate the third plurality of phase shifters of the analog APR to maximize an amplitude of the first pilot tone in the in-phase component and to minimize an amplitude of the first pilot tone in the quadrature-phase component such that in-phase and quadrature-phase crosstalk is minimized between the in-phase component and the quadrature-phase component of the first polarization.

In FIG. 2A, a first pilot tone is applied only to the in-phase component of X polarization of the IQM 212 in order to control the I-Q phase in X-polarization. This is under the assumption that the I-Q phase rotation is the same for both X and Y polarizations, which is feasible under a single transceiver chip condition. However, if there is a concern about the unexpected practical operating conditions that I-Q phase rotations could be different between X and Y polarizations, then a second pilot tone may be applied to the in-phase component of Y polarization, and a second APR may be added at the receiver side.

As indicated above, FIG. 2A is provided as an example. Other examples may differ from what is described with regard to FIG. 2A.

FIG. 2B shows an SHD coherent transceiver 200B according to one or more implementations. The SHD coherent transceiver 200B includes two sets of SHD coherent transceivers described in FIG. 1C.

In each set of SHD coherent transceiver in 200B, it uses a single-polarization data signal and single-polarization LO signal (e.g., a remotely sent local oscillator signal), which propagate in a same optical fiber and are received at the same silicon photonic receiver chip. In each set of SHD coherent transceiver, signal transmission port TXO transmits a polarization-multiplexed signal comprising of a single-polarization data signal and a single-polarization LO signal to a same fiber intended for another SHD coherent transceiver. The two sets of SHD coherent transceiver in 200B are operated at two different wavelengths (e.g., wavelength 1 and wavelength 2) and two LO lasers at wavelength1 and wavelength 2 are coupled to PIC 202 at optical ports TLO1 and TOL2, respectively. In the first set of SHD transmitter, the power splitter 213 splits laser input 1 into two paths, one of which is modulated by the I-Q modulator (IQM) 215. The two paths of LO1 219 and data signal modulated by 215 are re-combined at the polarization rotator combiner 217. The polarization rotator combiner 217 first rotates the X-polarized LO1 219 to Y-polarized LO1 and combines it with the X-polarized TX data signal modulated by 215. In the second set of SHD transmitter, the power splitter 223 splits laser input 2 into two paths, one of which is modulated by the I-Q modulator (IQM) 225. The two paths of LO1 229 and data signal modulated by 225 are re-combined at the polarization rotator combiner 227. The polarization rotator combiner 227 first rotates the X-polarized LO2 229 to a Y-polarized LO2 and combines it with the X-polarized TX data signal modulated by 225. An optical interleaver 226 combines the outputs of 217 at wavelength 1 and 227 at wavelength 2 for transmission on a single fiber. A first pilot tone is applied at VOA 214 to the I-phase component of the TX data signal 215 at wavelength 1, and a second pilot tone is applied at VOA 224 to the I-phase component of the TX data signal 225 at wavelength 2. Conversely, signal reception port RXI receives a two-wavelength signals from a same fiber from another SHD coherent transceiver. An optical interleaver 228 splits the two wavelengths to two SHD coherent receivers. In the first SHD coherent receiver, APC2-1 receives a polarization-multiplexed signal comprising of single-polarization remotely sent local oscillator signal and a single-polarization data signal at wavelength 1 and split the two in orthogonal polarizations into two paths, which are fed to optical hybrid 216. In the second SHD coherent receiver, APC2-2 receives a polarization-multiplexed signal comprising of single-polarization remotely sent local oscillator signal and single-polarization data signal at wavelength 2 and split the two in orthogonal polarizations into two paths, which are fed to optical hybrid 218.

In this case the path difference between single-polarization data signal and the remotely sent local oscillator signal at wavelength 1 (or at wavelength 2) can be negligible, and therefore no APR or APC1 is needed. Only APC2 is needed in this case.

Two pilot tones applied at VOA 214 and 224 at transmitter side are used by APC2-1 and APC2-2, respectively.

As indicated above, FIG. 2B is provided as an example. Other examples may differ from what is described with regard to FIG. 2B.

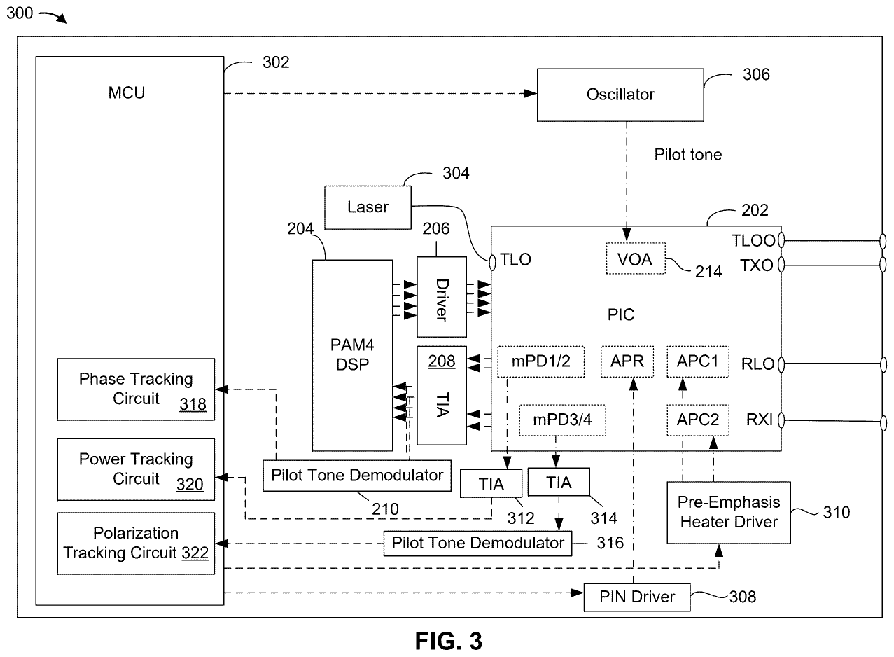

FIG. 3 shows an SHD coherent transceiver 300 according to one or more implementations. The SHD coherent transceiver 300 may include a PIC 202, a PAM4 DSP chip 204, a driver 206, and TIA circuit 208, and a pilot tone demodulator 210, as described in connection with FIG. 2A. The SHD coherent transceiver 300 may further include a microcontroller unit (MCU) 302, a laser source 304, an oscillator 306, a PIN driver 308, a pre-emphasis heater driver 310, a pair of TIAs 312 respectively coupled to the monitoring photo-diodes mPD1 and mPD2, a pair of TIAs 314 respectively coupled to the monitoring photo-diodes mPD3 and mPD4, and a pilot tone demodulator 316. Additionally, the MCU 302 may include a phase tracking circuit 318, a power tracking circuit 320, and a polarization tracking circuit 322.

The laser source 304 may provide the LO signal to the LO input port TLO.

The oscillator 306 may provide a pilot tone to be superimposed on the transmitted optical signal. The VOA 214 may superimpose the provided pilot tone onto one phase component (I or Q) of one polarization component (X or Y) of the optical signal to be transmitted A PIN junction-based VOA 214 may be used to enable megahertz-range pilot tone modulation, which may be needed for a fast control loop implementation.

The PIN driver 308 may control forward bias voltages of the third plurality of phase shifters of the analog APR in order to control a phase shifting implemented by the third plurality of phase shifters. The phase tracking circuit 318 may generate one or more control signals for the PIN driver 308, and the PIN driver 308 may receive the one or more control signals from the MCU 302.

The pre-emphasis heater driver 310 may drive heaters that are thermally coupled to the plurality of first phase shifters of the first analog APC (APC1), and heaters that are thermally coupled to the plurality of second phase shifters of the second analog APC (APC2). Thus, by driving the heaters, the pre-emphasis heater driver 310 may control a phase shifting implemented by the plurality of first phase shifters of the first analog APC (APC1) and the plurality of second phase shifters of the second analog APC (APC2). The power tracking circuit 320 may generate one or more control signals for the pre-emphasis heater driver 310, for controlling the plurality of first phase shifters of the first analog APC (APC1), and the pre-emphasis heater driver 310 may receive the one or more control signals from the MCU 302. The polarization tracking circuit 322 may generate one or more control signals for the pre-emphasis heater driver 310, for controlling the plurality of second phase shifters of the second analog APC (APC2), and the pre-emphasis heater driver 310 may receive the one or more control signals from the MCU 302.

Alternatively, in some implementations, when the plurality of first phase shifters of the first analog APC (APC1) and the plurality of second phase shifters of the second analog APC (APC2) are PIN junction-based phase shifters, the pre-emphasis heater driver 310 may be replaced with a PIN driver for controlling the phase shifts.

The pair of TIAs 312, respectively coupled to the monitoring photo-diodes mPD1 and mPD2, may be used to monitor optical power in the respective polarization components output from analog APR. For example, the pair of TIAs 312 may convert currents into voltages that are representative of the optical power detected by the monitoring photo-diodes mPD1 and mPD2.

The pair of TIAs 314, respectively coupled to the monitoring photo-diodes mPD3 and mPD4, may be used to monitor amplitudes of the pilot tone in the respective polarization components output from second analog APC (APC2). For example, the pair of TIAs 314 may convert currents into voltages that are representative of the optical power detected by the monitoring photo-diodes mPD3 and mPD4. The voltages may be demodulated by the pilot tone demodulator 316 for sampling the amplitudes of the pilot tone in the respective polarization components output from second analog APC (APC2).

The pilot tone demodulator 210 may be used for phase tracking. The polarization-multiplexed signal may include a first pilot tone. The pilot tone demodulator 210 may be coupled to the phase tracking circuit 318 for providing demodulated signals to the phase tracking circuit 318. The pilot tone demodulator 210 may be coupled to the outputs of the TIAs of the TIA circuit 208 for demodulating the first pilot tone. For example, the pilot tone demodulator 210 may receive an in-phase component and a quadrature-phase component of a first polarization (e.g., an X-polarization), the in-phase component and the quadrature-phase component including the first pilot tone.

In some implementations, the output of the analog APR includes a first pair of output ports that output respective polarization components. The power tracking circuit 320 may monitor optical power in the respective polarization components output from analog APR, and calibrate the first plurality of phase shifters in order to equalize the optical power at the first pair of output ports.

In some implementations, the polarization multiplexed signal includes a first pilot tone, and the output of the second analog APC (APC2) includes a second pair of output ports that output respective polarization components including the first pilot tone. The polarization tracking circuit 322 may monitor amplitudes of the first pilot tone in the respective polarization components output from second analog APC (APC2), and calibrate the second plurality of phase shifters to maximize an amplitude of the first pilot tone in a first one of the respective polarization components and to minimize an amplitude of the first pilot tone in a second one of the respective polarization components such that polarization crosstalk between the second pair of output ports is minimized. Since the pilot tone was only added to one component of an IQM (e.g., an in-phase component) of a first polarization (e.g., an X-polarization), maximizing an amplitude of the first pilot tone in an in-phase component of X-polarization is equivalent to maximizing an amplitude of the first pilot tone in the in-phase component of the X-polarization.

In some implementations, the polarization-multiplexed signal includes a first pilot tone, the output of the analog APR includes a first pair of output ports that output respective polarization components, and the output of the second analog APC (APC2) includes a second pair of output ports that output respective polarization components including the first pilot tone. The phase tracking circuit 318 may receive an in-phase component and a quadrature-phase component of a first polarization (e.g., an X-polarization) after a coherent receiver TIAs 208, the in-phase component and the quadrature-phase component including the first pilot tone. The phase tracking circuit 318 may monitor amplitudes of the first pilot tone included in the in-phase component and the quadrature-phase component, and calibrate the third plurality of phase shifters to maximize an amplitude of the first pilot tone in the in-phase component and to minimize an amplitude of the first pilot tone in the quadrature-phase component such that in-phase and quadrature-phase crosstalk is minimized between the in-phase component and the quadrature-phase component of the first polarization.

To summarize, a polarization state of an optical signal propagating in an optical fiber may undergo a non-deterministic, dynamically varying, and essentially random transformation of a polarization state. However, two co-propagating orthogonal polarization states will experience the same transformations. Therefore, if an instantaneous polarization transformation can be resolved and a conjugate transformation applied, both polarization signals can be restored to distinct orientations and separably processable. The APC/APR is a hardware device/subsystem that tracks and conjugates the received polarization transformation. In conventional coherent systems, this conjugation is done in software (digital electrical domain) at the data rate, utilizing a significant fraction of the computing capacity and power and thermal budgets. APC1, APC2, and APR perform the polarization conjugation transparently in the analog optical domain (agnostic to the speed and detail of the data imprinted on the optical signal). Therefore, the APC1, the APC2, and the APR require nearly zero compute capacity, and impose a much lower power and thermal burden. Moreover, as a result of the APC1, the APC2, and the APR offloading processing functions from a coherent DSP, a PAM4 DSP can be used, which consumes less power and fewer computational resources than coherent DSPs that perform conjugation and other processing functions in software. Furthermore, when applied in an SHD system, a digital-domain compute burden can be further reduced at a cost of adding a second channel of analog polarization conjugation. Thus, one or more implementations may include a system that provides field-quality, cost-effective, APC/APR optical devices suitable for these applications, and hence enable the use of less sophisticated (e.g., less expensive and less power-hungry) DSP modules.

As indicated above, FIG. 3 is provided as an example. Other examples may differ from what is described with regard to FIG. 3.

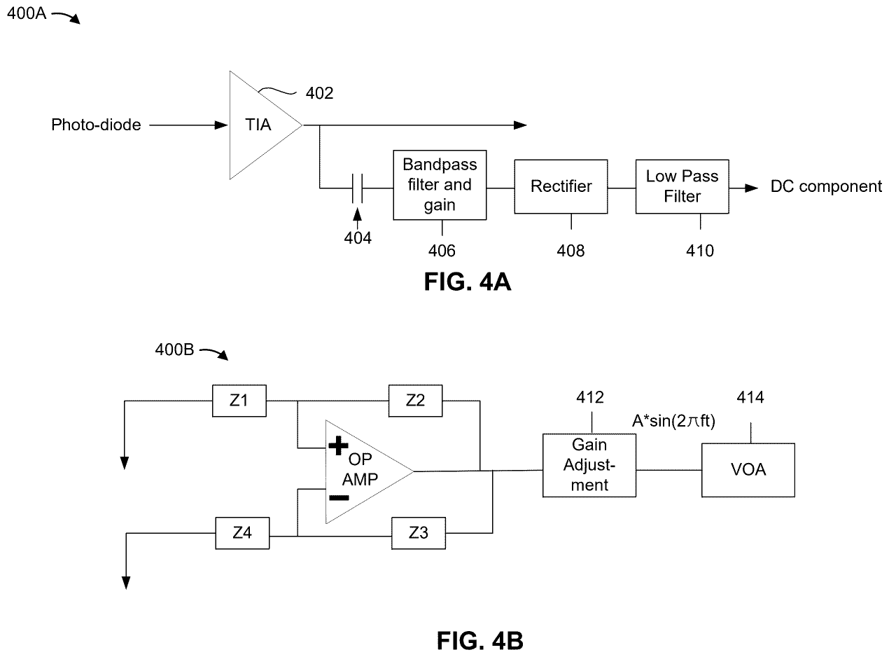

FIG. 4A shows a low-cost pilot tone recovery circuit 400A according to one or more implementations. The low-cost pilot tone recovery circuit 400A includes a TIA 402 (e.g., TIA 314), a capacitor 404, a bandpass filter and gain circuit 406, a rectifier 408, and a low pass filter 410. The low-cost pilot tone recovery circuit 400A may be used as a pilot tone demodulator (e.g., pilot tone demodulator 316). The low-cost pilot tone recovery circuit 400A may take advantage of a pilot tone frequency being known. A known pilot tone frequency may enable the low-cost pilot tone recovery circuit 400A to recover the pilot tone and generate a direct current (DC) component (e.g., a DC voltage) that may be sampled by a low-speed ADC to feed a proportional-integral-derivative (PID) control loop. A function of the PID control loop may be to maximize or minimize a sampled DC voltage. The TIA 402 may be used to amplify the pilot tone, which is fed to a bandpass filter and gain circuit 406, a rectifier 408, and a low pass filter 410. A resultant DC voltage may be sampled via a low-speed ADC. The rectification and low pass filter in analog electronics, enables the use of low-cost ADCs by converting a MHz bandwidth signal into a KHz bandwidth signal.

As indicated above, FIG. 4A is provided as an example. Other examples may differ from what is described with regard to FIG. 4A.

A pilot tone demodulation may need a reference radio-frequency local oscillator that has a stable frequency (e.g., 1 MHz) and phase. One way to generate the local oscillator is by using direct digital synthesis (DDS) circuitry. The DDS circuitry can generate a single-tone sinusoidal wave with a wide tunable frequency range from kilohertz to megahertz together with a fine resolution of 0.05 Hz. When compared to a traditional analog oscillator, the DDS circuitry has advantages such as high frequency stability, programmability, compactness, and a comparable power consumption.

FIG. 4B shows an operational amplifier-based oscillator 400B. Yet another low-cost solution capitalizes on a priori selection of the frequency of the pilot tone. Given that, an operational amplifier-based oscillator 400B may be used instead of DDS circuitry (in connection to 306 in FIG. 3). The output of the operational amplifier-based oscillator 400B may feed a gain adjustment stage 412, which is coupled to a TX VOA 414 (e.g., VOA 414 may correspond to VOA 214 in FIG. 3). Both the operational amplifier-based oscillator 400B and the gain adjustment stage 412 are low-cost components.

As indicated above, FIG. 4B is provided as an example. Other examples may differ from what is described with regard to FIG. 4B.

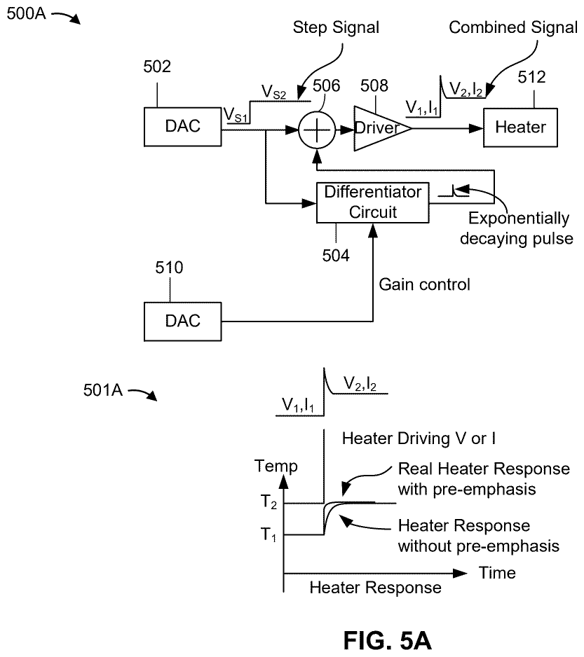

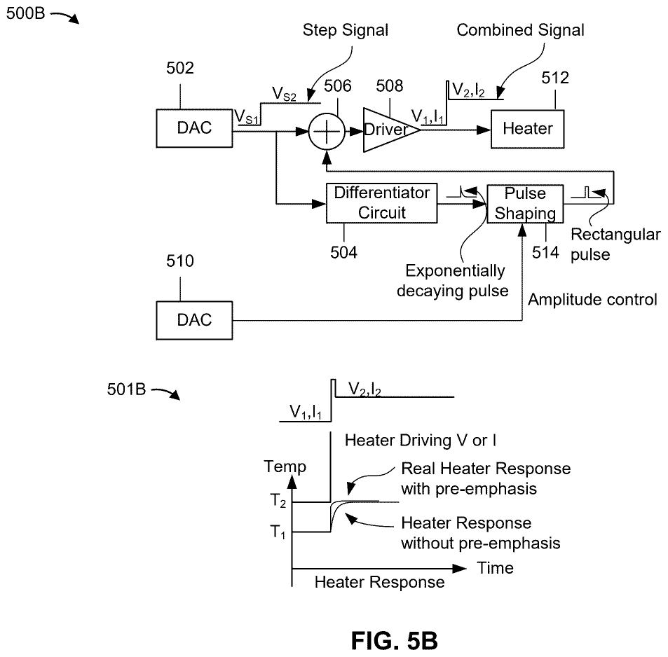

FIG. 5A shows a heater driving circuit 500A and a heater response function 501A according to one or more implementations. The heater driving circuit 500A may correspond to the pre-emphasis heater driver 310 described in connection with FIG. 3. The heater driving circuit 500A may drive heaters associated with the plurality of first phase shifters of the first analog APC (APC1) and heaters associated with the plurality of second phase shifters of the second analog APC (APC2).

The heater driving circuit 500A may include a first control signal generator 502 (e.g., a first digital-to-analog converter (DAC)), a differentiator circuit 504, a combiner 506, a driver 508, and a second control signal generator 510 (e.g., a second DAC). The heater driving circuit 500A is used to drive a heater 512.

The first control signal generator 502 may receive a digital control signal from a controller (e.g., MCU 302) and generate a step control signal, such as a voltage step, based on the digital control signal. The differentiator circuit 504 may detect an edge of the step control signal and generate a pulse signal having a pulse (e.g., a pre-emphasis pulse). The pulse may be an exponentially decaying pulse. The second control signal generator 510 may receive a digital control signal from a controller (e.g., MCU 302), generate a gain control signal based on the digital control signal, and provide the gain control signal to the differentiator circuit 504. The differentiator circuit 504 may adjust an amplitude of the pulse based on the gain control signal. The combiner 506 (e.g., a summing circuit) may combine the step control signal and the pulse signal to generate a combined control signal. The pulse signal (e.g., the pulse) is added to an initial portion of the step control signal such that an initial portion of the combined control signal has a pulse segment that is representative of the pulse. The heater driver 508 may receive the combined control signal and drive the heater 512 based on the combined control signal. The initial portion of the combined control signal, corresponding to the pulse of the pulse signal, decreases a response time of the heater 512. As a result, a temperature of the heater 512 changes more quickly, which results in a faster phase shift adjustment at a corresponding thermally-controlled phase shifter.

For example, the 3-dB bandwidth of a metal alloy or a metal heater is typically in a range of 5 kHz to 10 kHz. To achieve a sub-millisecond control loop interval, a heater bandwidth of around 50 kHz or greater is required. In some implementations, the heater 512 may be driven using the heater driving circuit 500A with a pre-emphasis pulse, which can improve heater response time. A control voltage and the pre-emphasis pulse are summed, and a summed control voltage is provided to the heater driver 508. The pre-emphasis pulse may be produced by passing the control voltage through the differentiator circuit 504. The differentiator circuit 504 may capture a step voltage change of a DAC output, for example, from voltage Vs1 to voltage Vs2. The differentiator circuit 504 may produce a signed pulse (e.g., a positive pulse for a rising edge of a rectangular wave signal, and a negative pulse for a falling edge of the rectangular wave signal).

The heater response function 501A illustrates that the heater response time from temperature T1 to temperature T2 is steeper, and thus faster, with the pre-emphasis pulse than without the pre-emphasis pulse.

As indicated above, FIG. 5A is provided as an example. Other examples may differ from what is described with regard to FIG. 5A.

FIG. 5B shows a heater driving circuit 500B and a heater response function 501B according to one or more implementations. The heater driving circuit 500B may correspond to the pre-emphasis heater driver 310 described in connection with FIG. 3. The heater driving circuit 500B may be similar to the heater driving circuit 500A described in connection with FIG. 5A. Thus, the heater driving circuit 500B and 500A may drive heaters associated with the plurality of first phase shifters of the first analog APC (APC1) and heaters associated with the plurality of second phase shifters of the second analog APC (APC2).

The heater driving circuit 500B may include a first control signal generator 502 (e.g., a first digital-to-analog converter (DAC)), a differentiator circuit 504, a combiner 506, a driver 508, and a second control signal generator 510 (e.g., a second DAC or a central processing unit (CPU)). The heater driving circuit 500B is used to drive a heater 512. Additionally, the heater driving circuit 500B may include a pulse shaping circuit 514 configured to reshape the pulse generated by the differentiator circuit into a rectangular pulse. Thus, the differentiator circuit 504 is configured to generate the pulse as an exponentially decaying pulse that is reshaped into the rectangular pulse by the pulse shaping circuit 514. The second control signal generator 510 may receive a digital control signal from a controller (e.g., MCU 302), generate an amplitude control signal based on the digital control signal, and provide the amplitude control signal to the pulse shaping circuit 514. The pulse shaping circuit 514 may adjust a duration and an amplitude of the rectangular pulse based on the amplitude control signal. The combiner 506 may receive the rectangular pulse from the pulse shaping circuit 514.

The heater response function 501B illustrates that the heater response time from temperature T1 to temperature T2 is steeper, and thus faster, with the pre-emphasis pulse than without the pre-emphasis pulse.

As indicated above, FIG. 5B is provided as an example. Other examples may differ from what is described with regard to FIG. 5B.

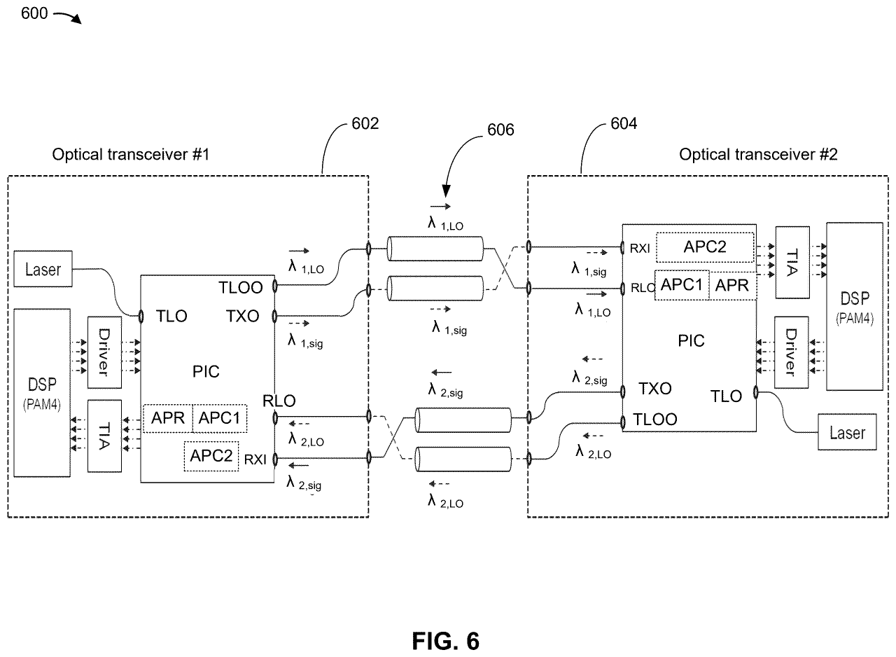

FIG. 6 shows an SHD coherent system 600 according to one or more implementations. The SHD coherent system 600 includes a first SHD coherent transceiver 602 and a second SHD coherent transceiver 604 coupled by two pairs of optical fibers 606. The first SHD coherent transceiver 602 and a second SHD coherent transceiver 604 may be similar to the SHD coherent transceiver 300 described in connection with FIG. 3. The first SHD coherent transceiver 602 may transmit a first polarization multiplexed signal λ_{1,sig} and a remotely sent local oscillator signal λ_{1,LO} to the second SHD coherent transceiver 604, and the second SHD coherent transceiver 604 may process the first polarization multiplexed signal λ_{1,sig} and the first remotely sent local oscillator signal λ_{1,LO} as described in connection with FIG. 3. The second SHD coherent transceiver 604 may transmit a second polarization multiplexed signal λ_{2,sig} and a second remotely sent local oscillator signal λ_{2,LO} to the first SHD coherent transceiver 602, and the first SHD coherent transceiver 602 may process the second polarization multiplexed signal λ_{2,sig} and the second remotely sent local oscillator signal λ_{2,LO} as described in connection with FIG. 3.

As indicated above, FIG. 6 is provided as an example. Other examples may differ from what is described with regard to FIG. 6.

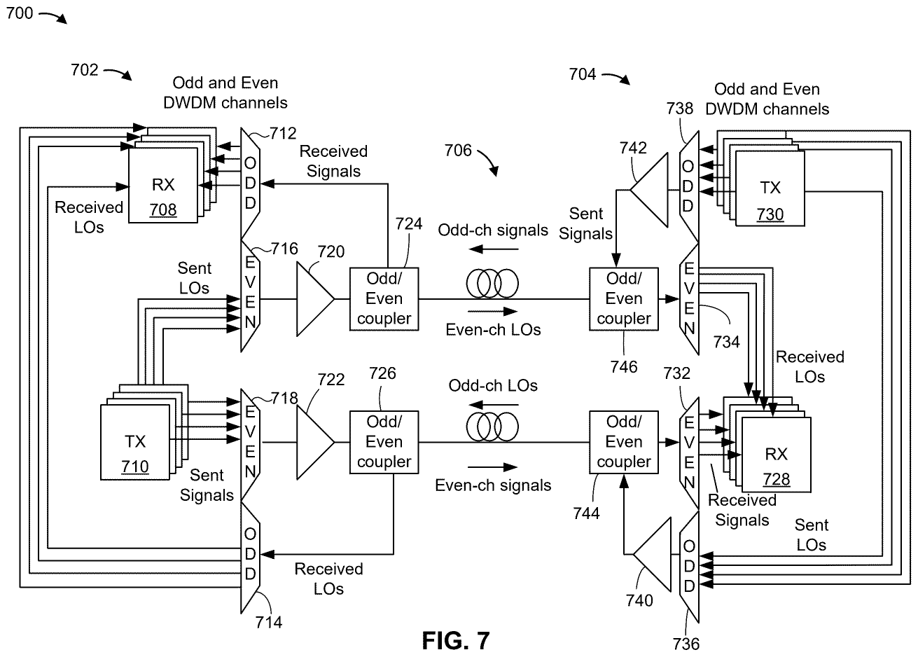

FIG. 7 shows an SHD coherent system 700 according to one or more implementations. The SHD coherent system 700 includes a first SHD coherent transceiver 702 and a second SHD coherent transceiver 704 coupled by two bi-directional optical fibers 706 (e.g., duplex optical fibers). SHD coherent optical transceivers can support multiple wavelength channels (e.g., CWDM, LWDM, and DWDM) for future intra-data center capacity growth. FIG. 7 shows a point-to-point LWDM/DWDM SHD coherent system architecture as an example of two SHD coherent transceivers supporting multiple wavelengths. The point-to-point LWDM/DWDM SHD coherent system architecture includes a bi-directional scheme, which has even and odd wavelength channels propagating in opposite directions in a same optical fiber. A signal that has an even wavelength channel number may be referred to as an even-channel signal. A signal that has an odd wavelength channel number may be referred to as an odd-channel signal.

The first SHD coherent transceiver 702 may include receiver channels 708, transmitter channels 710, an odd-channel RX demultiplexer 712 for odd-channel data signals, an odd-channel RX demultiplexer 714 for odd-channel LO signals, an even-channel TX multiplexer 716 for even-channel LO signals, an even-channel TX multiplexer 718 for even-channel data signals, an amplifier 720 for amplifying even-channel LO signals for transmission, an amplifier 722 for amplifying even-channel data signals for transmission, an odd/even coupler 724, and an odd/even coupler 726.

The odd/even coupler 724 may receive odd-channel data signals from the second SHD coherent transceiver 704, and may couple the odd-channel data signals to the odd-channel RX demultiplexer 712. The odd-channel RX demultiplexer 712 may couple the odd-channel data signals into respective receiver channels 708 for demodulation. The odd/even coupler 726 may receive odd-channel LO signals from the second SHD coherent transceiver 704, and may couple the odd-channel LO signals to the odd-channel RX demultiplexer 714. The odd-channel RX demultiplexer 714 may couple the odd-channel LO signals into respective receiver channels 708 for use for demodulating the odd-channel data signals via coherent detection.

The transmitter channels 710 may generate even-channel data signals and even-channel LO signals. Each transmitter channel 710 may correspond to a respective even wavelength. The even-channel TX multiplexer 716 may multiplex the even-channel LO signals onto a signal line coupled to the amplifier 720. The odd/even coupler 724 may receive the even-channel LO signals from the amplifier 720, and transmit the even-channel LO signals to the second SHD coherent transceiver 704. The even-channel TX multiplexer 718 may multiplex the even-channel data signals onto a signal line coupled to the amplifier 722. The odd/even coupler 726 may receive the even-channel data signals from the amplifier 722, and transmit the even-channel data signals to the second SHD coherent transceiver 704.

The odd/even coupler 724 may be coupled to or may represent a first bi-directional port for transmitting remotely sent local oscillator signals and for receiving further polarization multiplexed signals, with each remotely sent local oscillator signal consisting of a respective even wavelength, and each further polarization multiplexed signal consisting of a respective odd wavelength.

The odd/even coupler 726 may be coupled to or may represent a second bi-directional port for transmitting polarization multiplexed signals and for receiving further remotely sent local oscillator signals, with each polarization multiplexed signal consisting of a respective even wavelength, and each further remotely sent local oscillator signal consisting of a respective odd wavelength.

The second SHD coherent transceiver 704 may include receiver channels 728, transmitter channels 730, an even-channel RX multiplexer 732 for even-channel data signals, an even-channel RX multiplexer 734 for even-channel LO signals, an odd-channel TX multiplexer 736 for odd-channel LO signals, an odd-channel TX multiplexer 738 for odd-channel data signals, an amplifier 740 for amplifying odd-channel LO signals for transmission, an amplifier 742 for amplifying odd-channel data signals for transmission, an odd/even coupler 744, and an odd/even coupler 746. The second SHD coherent transceiver 704 may operate similarly to the first SHD coherent transceiver 702, except even-channel and odd-channel operations are reversed.

As indicated above, FIG. 7 is provided as an example. Other examples may differ from what is described with regard to FIG. 7.

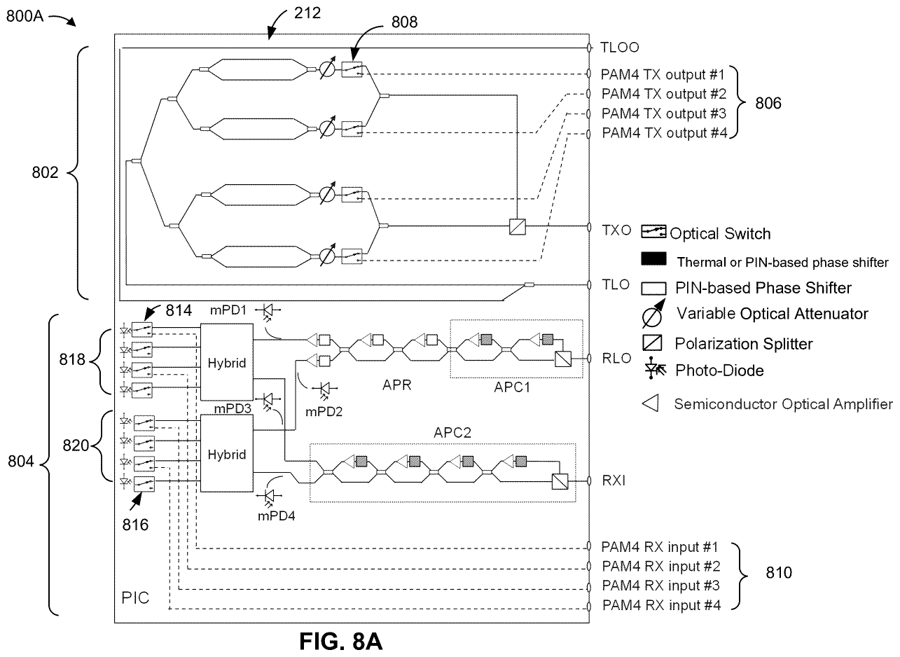

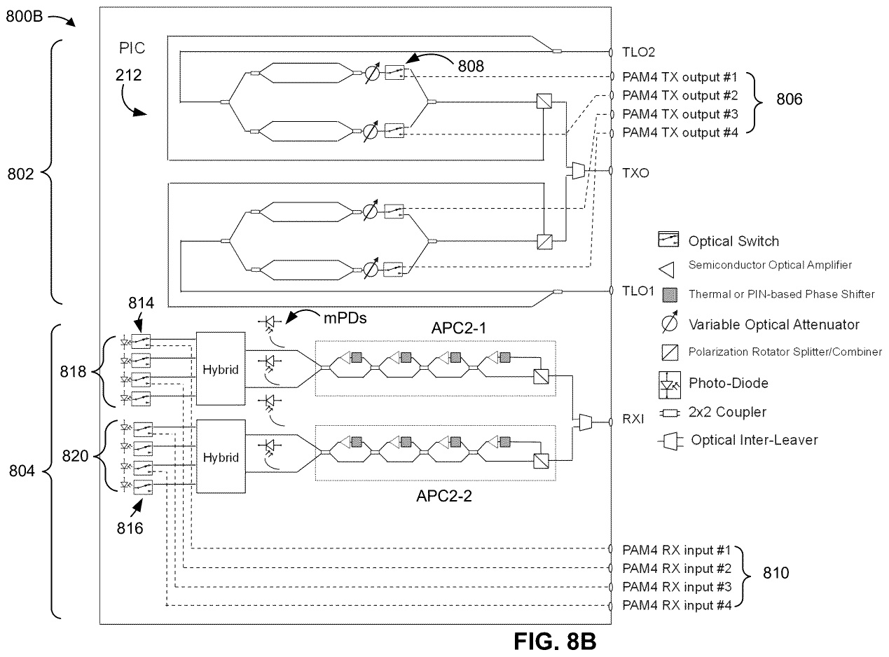

FIG. 8A shows a PIC 800A of an SHD coherent transceiver according to one or more implementations. The PIC 800A may be similar to the PIC 202 described in connection with FIG. 2A, with the exception that the PIC 800A is backward compatible with older generations of PAM4 transceivers and signals (e.g., PAM4 IMDD signals).

The PIC 800A includes a transmitter 802 compatible with a further SHD coherent transceiver and a non-coherent PAM4 transceiver. The PIC 800A further includes a receiver 804 compatible with the further SHD coherent transceiver and the non-coherent PAM4 transceiver.

The transmitter 802 includes four parallel transmission optical outputs 806 configured to be coupled to the non-coherent PAM4 transceiver. The transmitter 802 further includes a combined transmission optical output TXO configured to be coupled to the further SHD coherent transceiver. The transmitter 802 further includes an array of optical switches 808 configured to receive four parallel transmission signals. The array of optical switches 808 may be configurable into a first switch mode for coupling the four parallel transmission signals to the four parallel transmission optical outputs 806, respectively, for transmission. Additionally, the array of optical switches 808 may be configurable into a second switch mode for coupling the four parallel transmission signals to the combined transmission optical output TXO for transmission. Thus, in the first switch mode, the four parallel transmission signals are transmitted separately to be compatible with older generations of PAM4 transceivers. In the second switch mode, the four parallel transmission signals may be combined to generate a polarization-multiplexed signal, to be compatible with SHD coherent transceivers.

The receiver 804 may include a first reception optical input RXI configured to receive a polarization-multiplexed signal from the further SHD coherent transceiver, with a first local oscillator input RLO configured to receive a remotely sent local oscillator signal from the further SHD coherent transceiver. Thus, the first reception optical input RXI and the first local oscillator input RLO are compatible with SHD coherent transceivers. Additionally, the receiver 804 may include four parallel reception optical inputs 810 configured to be coupled to a non-coherent PAM4 transceiver for receiving four parallel transmission signals. Thus, the four parallel reception optical inputs 810 are compatible with older generations of PAM4 transceivers.

The receiver optical switches may include a first array of four optical switches 814 and a second array of four optical switches 816. The first array of four optical switches 814 may be configurable in a first switch mode for coupling first portions of the four parallel transmission signals to a first photo-diode circuit 818 for optical-to-electrical conversion. The first array of four optical switches 814 may be configurable in a second switch mode for coupling a first set of in-phase and quadrature (IQ) component signals, associated with the first data signal and the remotely sent local oscillator signal to the first photo-diode circuit 818 for optical-to-electrical conversion. The first data signal and the remotely sent local oscillator signal are described in connection with FIG. 2A, and 3.

The second array of four optical switches 816 may be configurable in a first switch mode for coupling second portions of the four parallel transmission signals to a second photo-diode circuit 820 for optical-to-electrical conversion. The second array of four optical switches 816 may be configurable in a second switch mode for coupling a second set of IQ component signals, associated with the second data signal and the remotely sent local oscillator signal, to the second photo-diode circuit 820 for optical-to-electrical conversion. The second data signal and the remotely sent local oscillator signal are described in connection with FIG. 2A, and 3.

As indicated above, FIG. 8A is provided as an example. Other examples may differ from what is described with regard to FIG. 8A.

FIG. 8B shows a PIC 800B of an SHD coherent transceiver according to one or more implementations. The PIC 800B may be similar to the PIC 202 described in connection with FIG. 2B, with the exception that the PIC 800B is backward compatible with older generations of PAM4 transceivers and signals (e.g., PAM4 IMDD signals). The PIC 800B is backward compatible with older generations of PAM4 transceivers and signals in a similar way as PIC 800A is backward compatible, as described in connection with FIG. 8A. Here, the entire receiver 804 is in one single silicon photonic chip so as to minimize the data signal path and LO path difference.

As indicated above, FIG. 8B is provided as an example. Other examples may differ from what is described with regard to FIG. 8B.

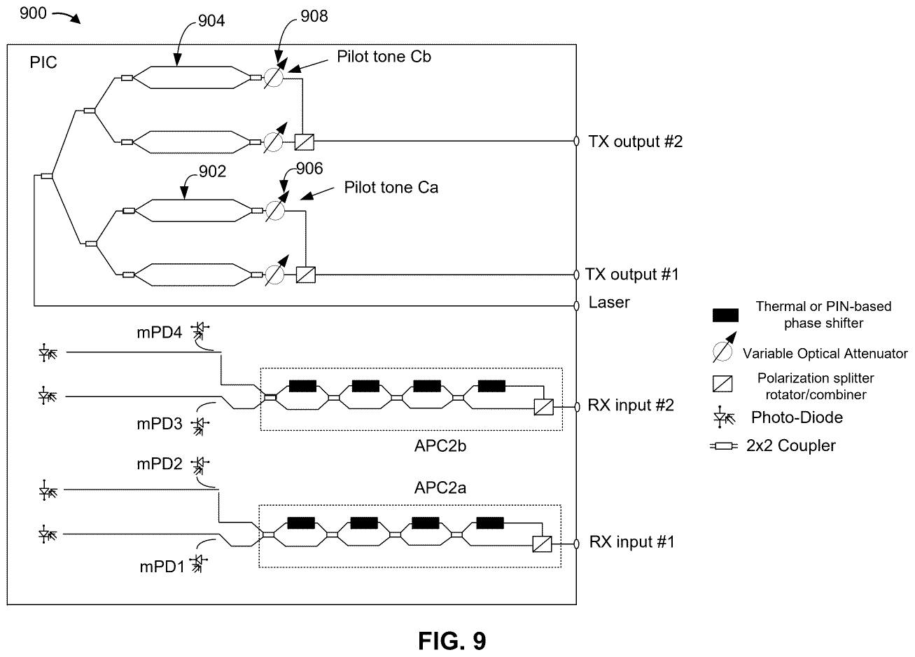

FIG. 9 shows a PIC 900 of an optical transceiver according to one or more implementations. The PIC 900 includes a first polarization-multiplexed silicon photonic PAM4 transmitter 902 for transmitting a first polarization-multiplexed signal from a first TX output port, and a second polarization-multiplexed silicon photonic PAM4 transmitter 904 for transmitting a second polarization-multiplexed signal from a second TX output port. A first VOA 906 may add a first pilot tone Ca to the first polarization-multiplexed signal. A second VOA 908 may add a second pilot tone Cb to the second polarization-multiplexed signal.

The PIC 900 further includes two second analog APCs (APC2s) coupled to respective RX input ports. The two second analog APCs (APC2s) include APC2a configured to perform a polarization-demultiplexing function for a first received polarization-multiplexed signal, and APC2b configured to perform a polarization-demultiplexing function for a second received polarization-multiplexed signal. APC2a may include a corresponding second polarization splitter rotator (e.g., a PSR) and a corresponding plurality of second phase shifters for signal polarization control. APC2a may split the first received polarization-multiplexed signal into a first respective data signal and a second respective data signal. APC2b may include a corresponding second polarization splitter rotator (e.g., a PSR) and a corresponding plurality of second phase shifters for signal polarization control. APC2b may split the second received polarization-multiplexed signal into a first respective data signal and a second respective data signal.

Monitoring photo-diodes mPD1 and mPD2 may be used for detecting amplitudes of a first pilot tone Ca for polarization tracking and for calibrating the corresponding plurality of second phase shifters of APC2a. Monitoring photo-diodes mPD3 and mPD4 may be used for detecting amplitudes of a second pilot tone Cb for polarization tracking and for calibrating the corresponding plurality of second phase shifters of APC2b.

A polarization tracking circuit may monitor amplitudes of the first pilot tone Ca in the respective polarization components output from APC2a, and calibrate the corresponding second plurality of phase shifters to maximize an amplitude of the first pilot tone in a first one of the respective polarization components and to minimize an amplitude of the first pilot tone in a second one of the respective polarization components such that polarization crosstalk between the output ports of APC2a is minimized.

A polarization tracking circuit may monitor amplitudes of the second pilot tone Cb in the respective polarization components output from APC2b, and calibrate the corresponding second plurality of phase shifters to maximize an amplitude of the second pilot tone in a first one of the respective polarization components and to minimize an amplitude of the second pilot tone in a second one of the respective polarization components such that polarization crosstalk between the output ports of APC2b is minimized.

As indicated above, FIG. 9 is provided as an example. Other examples may differ from what is described with regard to FIG. 9.

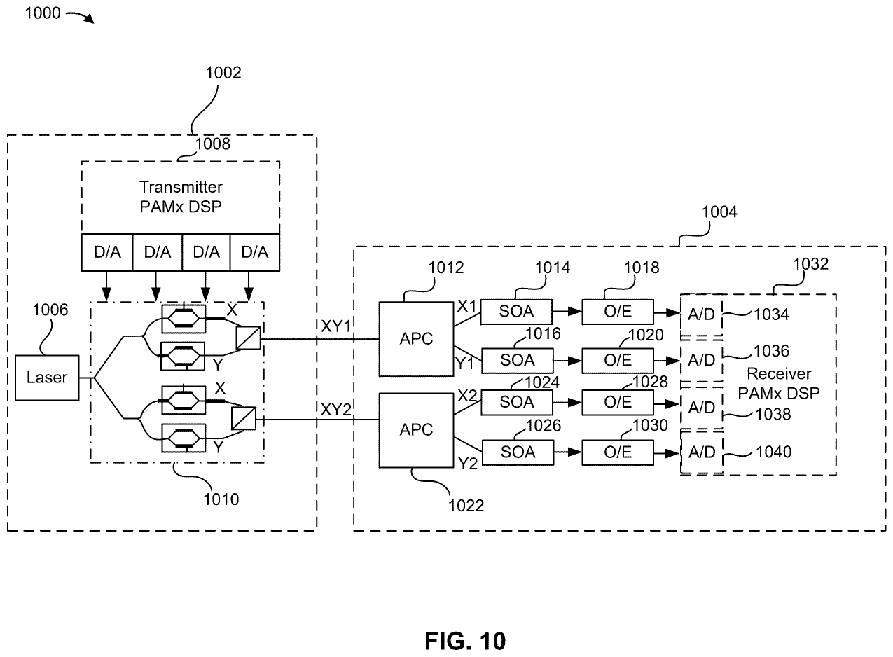

FIG. 10 shows a polarization-multiplexed IMDD transceiver 1000 according to one or more implementations. The polarization-multiplexed IMDD transceiver 1000 may include a transmitter 1002 and a receiver 1004. The transmitter 1002 may include a laser source 1006, a transmitter PAMx DSP 1008, and a modulator 1010. The transmitter PAMx DSP 1008 may be a transmitter PAM4 DSP, a transmitter PAM6 DSP, or a transmitter PAM8 DSP. Thus, the “x” in PAMx is a placeholder for a number of levels in a multilevel modulation format. The modulator 1010 may be based on silicon photonic Mach-Zehnder modulators (MZM), or micro-ring modulators, or electro-absorption modulated lasers. The modulator 1010 may transmit a first polarization-multiplexed PAM signal XY1, comprising two PAM data signals having different polarizations (e.g., X-and Y-polarizations) and carrying different sets of information. Additionally, the modulator 1010 may transmit a second polarization-multiplexed PAM signal XY2, comprising two PAM data signals having different polarizations (e.g., X-and Y-polarizations) and carrying different sets of information

The receiver 1004 may receive the first polarization-multiplexed PAM signal XY1 and the second polarization-multiplexed PAM signal XY2 at respective RX ports. The receiver 1004 may include an analog APC 1012 that includes a plurality of PIN-junction phase shifters for signal polarization control. The analog APC 1012 may split the first polarization-multiplexed PAM signal XY1 into a first PAM data signal X1 and a second PAM data signal Y1. The receiver 1004 may include SOA 1014 and SOA 1016 coupled to the analog APC 1012 to compensate for loss introduced by the plurality of PIN-junction phase shifters of the analog APC 1012. The receiver 1004 may include opto-electrical converters 1018 and 1020 (e.g., photodetectors and TIAs) for converting the first PAM data signal X1 and the second PAM data signal Y1 to electrical signals.

The receiver 1004 may include an analog APC 1022 that includes a plurality of PIN-junction phase shifters for signal polarization control. The analog APC 1022 may split the second polarization-multiplexed PAM signal XY2 into a third PAM data signal X2 and a fourth PAM data signal Y2. The receiver 1004 may include SOA 1024 and SOA 1026 coupled to the analog APC 1022 to compensate for loss introduced by the plurality of PIN-junction phase shifters of the analog APC 1022. The receiver 1004 may include opto-electrical converters 1028 and 1030 (e.g., photodetectors and TIAs) for converting the third PAM data signal X2 and the fourth PAM data signal Y2 to electrical signals.

The receiver 1004 may include a PAMx DSP chip 1032 that includes a plurality of ADCs. For example, the PAMx DSP chip 1032 may include a first ADC 1034 configured to convert the first PAM data signal X1 into a first digital signal, a second ADC 1036 configured to convert the second PAM data signal Y1 into a second digital signal, a third ADC 1038 configured to convert the third PAM data signal X2 into a third digital signal, and a fourth ADC 1040 configured to convert the fourth PAM data signal Y2 into a fourth digital signal. The PAMx DSP chip 1032 is configured to process the first digital signal, the second digital signal, the third digital signal, and the fourth digital signal.

The transmitter 1002 and the receiver 1004 may be scaled according to the number of levels in the multilevel modulation format. For example, a quantity of components may be doubled for transmitting/receiving four polarization-multiplexed PAM signals. In another example, a quantity of components may be quadrupled for transmitting/receiving eight polarization-multiplexed PAM signals.

As indicated above, FIG. 10 is provided as an example. Other examples may differ from what is described with regard to FIG. 10.

The foregoing disclosure provides illustration and description, but is not intended to be exhaustive or to limit the implementations to the precise forms disclosed. Modifications and

variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A self-homodyne detection (SHD) coherent transceiver, comprising:
a receiver configured to receive a polarization-multiplexed signal, comprising two data signals having orthogonal polarizations and carrying different sets of information, and a remotely sent local oscillator signal,
wherein the receiver comprises:
a first analog adaptive polarization controller (APC) configured to receive the remotely sent local oscillator signal, the first analog APC comprising a first polarization splitter rotator and a plurality of first phase shifters for polarization control of the remotely sent local oscillator signal, wherein the first analog APC is configured to split the remotely sent local oscillator signal into two portions, including a first remotely sent local oscillator signal and a second remotely sent local oscillator signal;
a second analog APC configured to receive the polarization-multiplexed signal, the second analog APC comprising a second polarization splitter rotator and a plurality of second phase shifters for signal polarization control, wherein the second analog APC is configured to split the polarization-multiplexed signal into a first data signal and a second data signal in orthogonal polarization states;
an analog adaptive phase rotator (APR) coupled to an output of the first analog APC, the analog APR comprising a plurality of third phase shifters configured to control respective phases of the first remotely sent local oscillator signal and the second remotely sent local oscillator signal for carrier phase error compensation; and
a 4-level pulse amplitude modulation (PAM4) digital signal processor (DSP) chip coupled to outputs of a coherent receiver, which includes the first analog APC, the second analog APC, and the analog APR followed by a coherent receiver circuit.

2. The SHD coherent transceiver of claim 1, wherein the coherent receiver circuit comprises:
a first optical hybrid configured to receive the first data signal and the first remotely sent local oscillator signal, and generate a first set of in-phase and quadrature (IQ) component signals;
a second optical hybrid configured to receive the second data signal and the second remotely sent local oscillator signal, and generate a second set of IQ component signals;
a first photo-diode pair configured to convert the first set of IQ component signals into first electrical signals;
a second photo-diode pair configured to convert the second set of IQ component signals into second electrical signals;
a first transimpedance amplifier pair coupled between the first photo-diode pair and a first pair of analog-to-digital converter circuits within the PAM4 DSP chip; and
a second transimpedance amplifier pair coupled between the second photo-diode pair and a second pair of analog-to-digital converter circuits within the PAM4 DSP chip.

3. The SHD coherent transceiver of claim 1, further comprising:
one or more semiconductor optical amplifiers (SOAs) coupled to the analog APR to compensate for loss introduced by the plurality of third phase shifters,
wherein the plurality of third phase shifters are PIN junction-based phase shifters.

4. The SHD coherent transceiver of claim 1, further comprising:
one or more first semiconductor optical amplifiers (SOAs) coupled to the first analog APC to compensate for loss introduced by the plurality of first phase shifters; and
one or more second SOAs coupled to the second analog APC to compensate for loss introduced by the plurality of second phase shifters,
wherein the plurality of first phase shifters and the plurality of second phase shifters are PIN junction-based phase shifters.

5. The SHD coherent transceiver of claim 1, wherein the plurality of first phase shifters and the plurality of second phase shifters are thermally-controlled phase shifters, and
wherein the plurality of third phase shifters are silicon photonics PIN junction-based phase shifters.

6. The SHD coherent transceiver of claim 1, wherein the plurality of first phase shifters, the plurality of second phase shifters, and the plurality of third phase shifters are silicon photonics PIN junction phase shifters.

7. The SHD coherent transceiver of claim 1, wherein the receiver further comprises:
a heater driving circuit configured to drive a heater that is thermally coupled to a first phase shifter of the plurality of first phase shifters, the heater driving circuit comprising:
a control signal generator configured to generate a step control signal;
a differentiator circuit configured to detect an edge of the step control signal and generate a pulse signal having a pulse;
a combiner configured to combine the step control signal and the pulse signal to generate a combined control signal, wherein the pulse signal is added to an initial portion of the step control signal; and
a driver configured to receive the combined control signal and drive the heater based on the combined control signal, wherein an initial portion of the combined control signal, corresponding to the pulse of the pulse signal, decreases a response time of the heater.

8. The SHD coherent transceiver of claim 7, wherein the differentiator circuit is configured to generate the pulse as an exponentially decaying pulse,
wherein the differentiator circuit is configured to receive a gain control signal from a digital-to-analog converter (DAC), and adjust an amplitude of the pulse based on the gain control signal.

9. The SHD coherent transceiver of claim 7, further comprising:
a pulse shaping circuit configured to reshape the pulse into a rectangular pulse,
wherein the differentiator circuit is configured to generate the pulse as an exponentially decaying pulse that is reshaped into the rectangular pulse by the pulse shaping circuit,
wherein the pulse shaping circuit is configured to receive an amplitude control signal from a digital-to-analog converter (DAC), and adjust a duration and an amplitude of the rectangular pulse based on the amplitude control signal, and
wherein the combiner is configured to receive the rectangular pulse.

10. The SHD coherent transceiver of claim 1,
wherein the output of the analog APR includes a first pair of output ports that output respective polarization components,
and
wherein the receiver further comprises a power tracking circuit is configured to:
monitor optical power in the respective polarization components output from analog APR, and
calibrate the first plurality of phase shifters in order to equalize the optical power at the first pair of output ports.

11. The SHD coherent transceiver of claim 1, wherein the polarization-multiplexed signal comprises a first pilot tone,
wherein the output of the second analog APC includes a second pair of output ports that output respective polarization components including the first pilot tone, and
wherein the receiver further comprises a polarization tracking circuit configured to:
monitor amplitudes of the first pilot tone in the respective polarization components output from second analog APC, and
calibrate the second plurality of phase shifters to maximize an amplitude of the first pilot tone in a first one of the respective polarization components and to minimize an amplitude of the first pilot tone in a second one of the respective polarization components such that polarization crosstalk between the second pair of output ports is minimized.

12. The SHD coherent transceiver of claim 1, wherein the polarization-multiplexed signal comprises a first pilot tone,
wherein the output of the analog APR includes a first pair of output ports that output respective polarization components,
wherein the output of the second analog APC includes a second pair of output ports that output respective polarization components including the first pilot tone, and
wherein the receiver further comprises a phase tracking circuit configured to:
receive a first phase component and a second phase component of a first polarization, the second phase component being in quadrature to the first phase component, and the first phase component and the second phase component including the first pilot tone,
monitor amplitudes of the first pilot tone included in the first phase component and the second phase component, and
calibrate the third plurality of phase shifters to maximize an amplitude of the first pilot tone in the first phase component of the first polarization and to minimize an amplitude of the first pilot tone in the second phase component of the first polarization such that in-phase and quadrature-phase crosstalk is minimized between the first phase component and the second phase component of the first polarization.

13. The SHD coherent transceiver of claim 1, further comprising:
a transmitter compatible with a further SHD coherent transceiver and a non-coherent PAM4 transceiver, the transmitter comprising:
four parallel transmission optical outputs configured to be coupled to the non-coherent PAM4 transceiver;
a combined transmission optical output configured to be coupled to the further SHD coherent transceiver; and
an array of optical switches configured to receive four parallel transmission signals,
wherein the array of optical switches are configurable into a first switch mode for coupling the four parallel transmission signals to the four parallel transmission optical outputs, respectively, for transmission, and
wherein the array of optical switches are configurable into a second switch mode for coupling the four parallel transmission signals to the combined transmission optical output for transmission.

14. The SHD coherent transceiver of claim 1, wherein the receiver is compatible with a further SHD coherent transceiver and a non-coherent PAM4 transceiver,
wherein the receiver further comprises:
a first reception optical input configured to receive the polarization-multiplexed signal from the further SHD coherent transceiver;
a first local oscillator input configured to receive the remotely sent local oscillator signal from the further SHD coherent transceiver;
four parallel reception optical inputs configured to be coupled to the non-coherent PAM4 transceiver for receiving four parallel transmission signals;
a first array of four optical switches configurable in:
a first switch mode for coupling first portions of the four parallel transmission signals to a first photo-diode circuit for optical-to-electrical conversion, and
a second switch mode for coupling a first set of in-phase and quadrature (IQ) component signals, associated with the first data signal and the remotely sent local oscillator signal, to the first photo-diode circuit for optical-to-electrical conversion; and
a second array of four optical switches configurable in:
a first switch mode for coupling second portions of the four parallel transmission signals to a second photo-diode circuit for optical-to-electrical conversion, and
a second switch mode for coupling a second set of IQ component signals, associated with the second data signal and the remotely sent local oscillator signal, to the second photo-diode circuit for optical-to-electrical conversion.

15. The SHD coherent transceiver of claim 1, wherein the analog APR is an endless phase rotator to compensate for a phase delay difference between the polarization-multiplexed signal and the remotely sent local oscillator signal.

16. The SHD coherent transceiver of claim 1, further comprising:
a transmitter comprising:
a first sub-data rate modulator configured to add, via amplitude modulation, a first pilot tone to a phase component of the first polarization of the polarization-multiplexed signals.

17. The SHD coherent transceiver of claim 16, wherein the first sub-data rate modulator is a PIN-junction-based variable optical attenuator (VOA).

18. The SHD coherent transceiver of claim 1, further comprising:
a first bi-directional port for transmitting the remotely sent local oscillator signal and for receiving a further polarization-multiplexed signal,
wherein the remotely sent local oscillator signal consists of even wavelengths, and
wherein the further polarization-multiplexed signal consists of odd wavelengths; and
a second bi-directional port for transmitting the polarization-multiplexed signal and for receiving a further remotely sent local oscillator signal,
wherein the polarization-multiplexed signal consists of even wavelengths, and
wherein the further remotely sent local oscillator signal consists of odd wavelengths.

19. A self-homodyne detection (SHD) coherent transceiver, comprising:
a coherent receiver configured to receive a polarization-multiplexed signal that includes a single-polarization data signal and a remotely sent local oscillator signal, the single-polarization data signal and the remotely sent local oscillator signal having orthogonal polarizations,
wherein the coherent receiver comprises:
an analog adaptive polarization controller (APC) configured to receive the polarization-multiplexed signal, including the single-polarization data signal and the remotely sent local oscillator signal, the analog APC comprising a plurality of phase shifters for separating the single-polarization data signal and the remotely sent local oscillator signal;
an optical hybrid having a first input coupled to a first output port of the analog APC, for receiving the single-polarization data signal, and coupled to a second output port of the analog APC, for receiving the remotely sent local oscillator signal; and
a 4-level pulse amplitude modulation (PAM4) digital signal processor (DSP) chip coupled to output ports of the optical hybrid.

20. The SHD coherent transceiver of claim 19, further comprising:
one or more semiconductor optical amplifiers (SOAs) coupled to the analog APC to compensate for loss introduced by the plurality of phase shifters,
wherein the plurality of phase shifters are PIN junction-based phase shifters.

21. The SHD coherent transceiver of claim 19, wherein the plurality of phase shifters are thermal phase shifters, and
the coherent receiver further comprises:
a heater driving circuit configured to drive a heater that is thermally coupled to a phase shifter of the plurality of phase shifters, the heater driving circuit comprising:
a control signal generator configured to generate a step control signal;
a differentiator circuit configured to detect an edge of the step control signal and generate a pulse signal having a pulse;
a combiner configured to combine the step control signal and the pulse signal to generate a combined control signal, wherein the pulse signal is added to an initial portion of the step control signal; and
a driver configured to receive the combined control signal and drive the heater based on the combined control signal, wherein an initial portion of the combined control signal, corresponding to the pulse of the pulse signal, decreases a response time of the heater.

22. The SHD coherent transceiver of claim 21, wherein the differentiator circuit is configured to generate the pulse as an exponentially decaying pulse,
wherein the differentiator circuit is configured to receive a gain control signal from a digital-to-analog converter (DAC), and adjust an amplitude of the pulse based on the gain control signal.

23. The SHD coherent transceiver of claim 21, further comprising:
a pulse shaping circuit configured to reshape the pulse into a rectangular pulse,
wherein the differentiator circuit is configured to generate the pulse as an exponentially decaying pulse that is reshaped into the rectangular pulse by the pulse shaping circuit,
wherein the pulse shaping circuit is configured to receive an amplitude control signal from a digital-to-analog converter (DAC), and adjust a duration and an amplitude of the rectangular pulse based on the amplitude control signal, and
wherein the combiner is configured to receive the rectangular pulse.

24. A polarization-multiplexed intensity modulation direct detection (IMDD) transceiver, comprising:
a receiver configured to receive a polarization-multiplexed pulse amplitude modulation (PAM) signal, comprising two PAM data signals having orthogonal polarizations and carrying different sets of information,
wherein the receiver comprises:
an analog adaptive polarization controller (APC) comprising a plurality of PIN-junction phase shifters for signal polarization control, wherein the analog APC is configured to split the polarization-multiplexed PAM signal into a first PAM data signal and a second PAM data signal;
one or more semiconductor optical amplifiers (SOAs) coupled to the analog APC to compensate for loss introduced by the plurality of PIN-junction phase shifters; and
a PAM digital signal processor (DSP) chip comprising:
a first analog-to-digital converter (ADC) configured to convert the first PAM data signal into a first digital signal; and
a second ADC configured to convert the second PAM data signal into a second digital signal,
wherein the PAM DSP chip is configured to process the first digital signal and the second digital signal.

25. A self-homodyne detection (SHD) coherent transceiver, comprising:
a coherent receiver portion that receives a two-wavelength polarization-multiplexed signals from the same fiber from another SHD coherent transceiver, the coherent receiver portion comprising:
an optical interleaver configured to split each of the two-wavelength polarization-multiplexed signals to two paths, including a first path and a second path, wherein the optical interleaver is configured to provide a first single-polarization data signal and a first single-polarization remotely sent local oscillator signal to the first path, and provide a second single-polarization data signal and a second single-polarization remotely sent local oscillator signal to the second path; and
two sets of coherent receivers, including a first coherent receiver and a second coherent receiver,
wherein the first coherent receiver, associated with the first path, comprises:
a first analog adaptive polarization controller (APC) coupled to a first output of the optical interleaver; and
a first optical hybrid configured to receive the first single-polarization data signal and the first single-polarization remotely sent local oscillator, and generate a first set of in-phase and quadrature (IQ) component signals;
a first photo-diode pair configured to convert the first set of IQ component signals into first electrical signals; and
a first transimpedance amplifier pair coupled between the first photo-diode pair and a first pair of analog-to-digital converter circuits integrated within a 4-level pulse amplitude modulation (PAM4) DSP chip, and
wherein the second coherent receiver, associated with the second path, comprises:
a second analog APC coupled to a second output of the optical interleaver;
a second optical hybrid configured to receive the second single-polarization data signal and the second single-polarization remotely sent local oscillator, and generate a second set of IQ component signals;
a second photo-diode pair configured to convert the second set of IQ component signals into second electrical signals; and
a second transimpedance amplifier pair coupled between the second photo-diode pair and a second pair of analog-to-digital converter circuits integrated within the PAM4 DSP chip.

26. The SHD coherent transceiver of claim 25, further comprising:
a coherent transmitter portion configured to transmit two-wavelength polarization-multiplexed transmit signals in the same transmit fiber, the coherent transmitter portion comprising:
two sets of coherent transmitters operating at different wavelengths, including first coherent transmitter and a second coherent transmitter,
wherein the first coherent transmitter is configured to transmit a first single-polarization data transmit signal and a first single-polarization LO transmit signal, wherein a first pilot tone is applied by a first variable optical attenuator (VOA) to a first phase component of the first single-polarization data transmit signal at a first wavelength,
wherein the second coherent transmitter is configured to transmit a second single-polarization data transmit signal and a second single-polarization LO transmit signal,
wherein a second pilot tone is applied by a second VOA to a second phase component of the second single-polarization data transmit signal at a second wavelength; and
an optical interleaver configured to combine outputs of the two sets of coherent transmitters operating at different wavelengths.

27. The SHD coherent transceiver of claim 25, further comprising:
a transmitter compatible with a further SHD coherent transceiver and a non-coherent 4-level pulse amplitude modulation (PAM4) transceiver, the transmitter comprising:
four parallel transmission optical outputs configured to be coupled to the non-coherent PAM4 transceiver;
a combined transmission optical output configured to be coupled to the further SHD coherent transceiver; and
an array of optical switches configured to receive four parallel transmission signals,
wherein the array of optical switches are configurable into a first switch mode for coupling the four parallel transmission signals to the four parallel transmission optical outputs, respectively, for transmission, and
wherein the array of optical switches are configurable into a second switch mode for coupling the four parallel transmission signals to the combined transmission optical output for transmission.

28. The SHD coherent transceiver of claim 25, wherein the coherent receiver portion is compatible with a further SHD coherent transceiver and a non-coherent 4-level pulse amplitude modulation (PAM4) transceiver,
wherein the coherent receiver portion further comprises:
a first reception optical input configured to receive the two-wavelength polarization-multiplexed signals from the further SHD coherent transceiver;
four parallel reception optical inputs configured to be coupled to the non-coherent PAM4 transceiver for receiving four parallel transmission signals;
a first array of four optical switches configurable in:
a first switch mode for coupling first portions of the four parallel transmission signals to a first photo-diode circuit for optical-to-electrical conversion, and
a second switch mode for coupling a first set of in-phase and quadrature (IQ) component signals, associated with a first data signal and a remotely sent local oscillator signal of a first wavelength, to the first photo-diode circuit for optical-to-electrical conversion; and
a second array of four optical switches configurable in:
a first switch mode for coupling second portions of the four parallel transmission signals to a second photo-diode circuit for optical-to-electrical conversion, and
a second switch mode for coupling a second set of IQ component signals, associated with a second data signal and a remotely sent local oscillator signal of a second wavelength, to the second photo-diode circuit for optical-to-electrical conversion.
